(19) United States
(12) Patent Application Publication
(10) Pub. No.: US 2021/0271886 A1
(43) Pub. Date: Sep. 2, 2021

(54) SYSTEM AND METHOD FOR CAPTURING, INDEXING AND EXTRACTING DIGITAL WORKFLOW FROM VIDEOS USING ARTIFICIAL INTELLIGENCE

(71) Applicant: DeepHow Corp., Princeton, NJ (US)

(72) Inventors: Xianjun Sam Zheng, Plainsboro, NJ (US); Patrik Matos da Silva, Brooklyn, NY (US); Wei-Liang Kao, Van Buren Twp., MI (US)

(21) Appl. No.: 17/187,528

(22) Filed: Feb. 26, 2021

Related U.S. Application Data
(60) Provisional application No. 62/984,035, filed on Mar. 2, 2020.

(51) Int. Cl. G06K 9/00; G06F 16/41; G06Q 10/06

(52) U.S. Cl. CPC G06K 9/00718; G06Q 10/0633; G06F 16/41; G06K 9/00744

(57) ABSTRACT

An AI (artificial intelligence) system has been developed that uses an AI module wherein the AI system captures, indexes, and extracts digital workflow of complex technical know-how for designing, manufacturing, operating, maintaining and servicing products, machines and equipment, and turns the digital workflow into a GPS-map like, step-by-step interactive workflow guidance. The AI system uses a workflow acquisition system, which captures and digitizes experts' knowledge and workflow as they are physically performing their work or task in a spatial environment. The workflow acquisition system includes one or multiple video input devices such as cameras that capture videos from multiple perspectives, including but not limited to side-view and point-of-view (POV) in which the cameras can be head-mounted, eye-wearable, or shoulder-mounted. The AI system and the AI module thereof analyzes and indexes the audios and every frame of the videos to extract the workflow content, such as objects, activities, and states, from the video using one or more AI methods, such as NLP (natural language processing) or computer vision, such as object detection and activity recognition. The extracted digital workflows, including step-by-step information, are stored preferably in a cloud based enterprise knowledge repository, which can be used to teach and train workers in these skilled trades and help speed up the learning curve for individuals learning a new skill such as those replacing more senior workers. Authorized users can access this digital workflow content as interactive how-to videos anytime, anywhere and learn at their own pace.

### CROSS REFERENCE TO RELATED APPLICATIONS

This application claims priority of U.S. Provisional Patent Application No. 62/984,035, filed Mar. 2, 2020, the disclosure of which is incorporated herein by reference in its entirety.

### FIELD OF THE INVENTION

The invention relates to a system and method for capturing and editing videos, and more particularly to a system and method for capturing, indexing, and extracting digital process steps such as workflow from videos using Artificial Intelligence (herein AI).

### BACKGROUND OF THE INVENTION

In a conventional work or business environment such as an industrial business, equipment may be provided that requires specialized skills to operate, service and/or repair. Often times, these specialized skills must be developed by the equipment operator over time through teaching, training and/or everyday experience. It can take years to develop such specialized skills and the knowledge base to perform such skills. Often, the skills and knowledge must be passed down through generations of equipment operators from experts or senior operators to novices or junior operators. The term operators is not intended to be limiting and includes those individuals operating the machines during daily operations but also any other individuals involved with the equipment such as those skilled in servicing, repairing, upgrading, or replacing such equipment. Ultimately, this experience leads to more efficient equipment operation and the tasks associated therewith, increased quality, faster performance of tasks, etc. As such, an experienced workforce is often a critical component for many businesses or other operations.

However, increased equipment complexity and a widening gap in the availability of an experienced workforce in most of the world is causing a negative impact for industrial businesses and other types of businesses or operations. These impacts include, for example: inefficient task execution; tasks performed with sub-optimal quality; rework due to errors; poor collaboration between experts and novices; tasks delayed due to expert availability and travel costs; expensive and time consuming training.

Traditionally, and still in most cases today, technical know-how is captured in static documents and distributed via printed paper or PDFs such as for providing work instructions, and recording and reporting the findings. However, this knowledge transfer can suffer from inefficiency, high cost, lengthy training, poor quality, and lost productivity. Some recent technologies provide a digital replication of the paper experience; and others offer multimedia or AR solutions, which rely on nascent hardware and software technologies and demand higher investment in content authoring. As such, these conventional processes for knowledge transfer suffer from substantial inefficiencies and the problems associated therewith.

It is an object of the invention to overcome such problems.

### SUMMARY OF THE INVENTION

An AI (artificial intelligence) system has been developed that uses an AI module that has been called Stephanie for reference. The inventive system captures, indexes, and extracts digital workflow of complex technical know-how for designing, manufacturing, operating, maintaining, and servicing products, machines, and equipment, and turns the digital workflow into a GPS-map like, step-by-step interactive workflow guidance. While the inventive AI system is particularly suitable for industrial businesses, the inventive AI system also is usable to extract non-industrial workflows such as other processes and task flows performed that are similarly based upon a specialized skill set and knowledge base. As such, the reference to workflow is not necessarily limited to those encountered in an industrial business.

Generally, the AI system may include multiple system modules for analyzing workflows for various operations, generating workflow outputs, and publishing workflow guidance and incorporating this data into such operations for improved performance of the workflow. These system modules comprise, but are not limited to, a workflow capturer or capture module, a workflow indexer or indexing module, a workflow builder or build module, a workflow navigator or navigation module and a skills analyzer or analyzer module. The workflow indexer or indexing module may incorporate therein an AI module, which uses AI to analyze the captured data and index same for subsequent processing wherein the various modules in turn may communicate with the AI module that analyzes and transfers data between the modules. Other modules may be incorporated into the AI system of the present invention.

More particularly, the AI system uses a workflow acquisition system, which captures and digitizes experts' knowledge and workflow as they are physically performing their work or task in a spatial environment. The workflow acquisition system includes one or multiple video input devices such as cameras that capture videos from multiple perspectives, including but not limited to side-view and point-of-view (POV) in which the cameras can be head-mounted, eye-wearable, or shoulder-mounted. The AI system may further comprise other data collection devices to further supplement the video and audio data. The AI Stephanie system and the AI module thereof analyzes and indexes the audios and every frame of the videos as well as any other captured data to extract the workflow content, such as objects, activities, and states, from the captured video and data using one or more AI methods, such as NLP (natural language processing) or computer vision, such as object detection and activity recognition.

The extracted digital workflows, including step-by-step information, are stored preferably in a cloud based enterprise knowledge repository, which can be used to teach and train workers in these skilled trades and help speed up the learning curve for individuals learning a new skills such as those replacing more senior workers. Authorized users can access this digital workflow content as interactive how-to videos anytime, anywhere and learn at their own pace.

In more detail, the invention overcomes disadvantages with the known systems for documenting technical know-how by providing an AI (artificial intelligence) system that captures, indexes, and extracts digital workflow of complex technical know-how for designing, manufacturing, operating, maintaining and servicing products, machines and equipment, and turns the digital workflow into a GPS-map like, step-by-step interactive workflow guidance. Generally, the workflow involves multiple related steps performed in a physical spatial environment. These may be performed in a business or industrial environment or other types of operational and physical environments.

The workflow capture module is a workflow acquisition system forming part of the AI Stephanie system that captures and digitizes experts' knowledge and workflow as they are physically performing their work in the work or operational environment. The workflow acquisition system includes one or multiple data input devices such as video cameras that capture videos from multiple perspectives, including but not limited to side-view and point-of-view (POV) in which cameras can be head-mounted, eye-wearable, or shoulder-mounted. The workflow capturer may also input or accept existing videos, diagrams, manuals, instructions, training plans and any other documented information that may have been developed to historically transfer knowledge from experts to novices.

The workflow acquisition system captures the physical movements and audio instructions or commentary of an individual performing their personal workflow patterns, and transfers digitized workflow data to the AI module. The physical movements and audio instructions, for example, may be performed in the performance of various tasks or jobs or other technical know-how and may include steps that might be unique to each individual. As such, these tasks may be performed differently between different individuals, and the inventive AI system is able to capture workflows and know how that is both common or standardized knowledge used within an industry but also the unique or subjective knowledge and know-how of an individual, wherein the subjective knowledge base may expand upon, depart from or differ from the common or standardized knowledge base.

These tasks may involve physical movement and audio from one or more individuals, and also may involve the use of objects such as tools and other devices and equipment to perform the task. While the primary type of captured data results from the collection of video and audio data, it will be recognized that other input devices may also be used which capture other types of input data such as timing data and sensor data in or around an object that may relate to movement, location, orientation or other attributes of the individual performing the task and the objects associated therewith. Some or all of this information is captured by the workflow acquisition system wherein the visual, audio, and other performance data is digitized for transfer to the AI module.

Preferably, the workflow is unscripted and performed naturally using the individual's expertise and know-how. In other words, the workflow is performed naturally by the individual without relying upon a script prepared beforehand. In effect, the individual performs the task through a stream of consciousness dictated by past training and experience. The AI system does not attempt to instruct the individual but rather, attempts to learn from the individual to teach more novice individuals.

The AI module of the AI system analyzes the input data and preferably indexes every frame of the videos, including the audio portions thereof, to extract the digital workflow content, such as objects, activities, and states, from the video using AI methods, such as NLP (natural language processing) or computer vision, such as object detection and activity recognition. Preferably, the AI module analyzes, edits, and organizes the digital workflow content and may automatically generate a step-by-step Interactive How-to Video using the digital workflow content or generate sub-components of a video, which may be individually edited and organized.

After processing by the AI module, experts can review the automatically extracted digital workflow contents using the workflow builder, such as step-by-step information, and can make edits or changes if needed. The editing may be performed on an initial version of an Interactive How-To Video or to the digital workflow content to correct, revise and/or organize the digital workflow content for production of a final version of the Interactive How-To-Video. Experts can also insert additional diagrams or instructions to supplement the collected workflow data with supplemental training data.

Once the review is completed with the workflow builder, the digital workflow contents are published to a cloud based enterprise knowledge repository or other data storage medium, which is accessible from a remote viewing module such as a computer or the like using the workflow navigation module. Authorized users, such as students and workers, can access these digital workflow content as interactive how-to videos anytime, anywhere through a suitable viewing module of the navigation module and learn at their own pace to teach and train the skilled trades and help speed up their learning curve.

The inventive AI system promotes the belief that people are the greatest asset to any company: for knowledge, for decision making and for execution. And despite the promise of robots, expert knowledge will remain the most valuable in the foreseeable future. People will continue to be more versatile, faster to train and deploy than any robots across the majority of manufacturing assembly, inspection, service, and logistics tasks for many years to come. Experienced workers embody a wealth of accumulated procedural knowledge, but as an older generation retires, this deep know-how is in danger of draining from the companies and institutions. Companies and institutions will recruit from younger generations in increasing numbers, and rather than learning by traditional training classes, they will expect new technology to furnish them with just enough information for them to become productive immediately. The present invention will facilitate the transition to a new generation of connected digital technicians, and aims to provide a critical platform to serve companies and other institutions by assisting their workforce and enabling informed and optimized execution.

As disclosed herein, the AI system uses a variety of tools and methods as the workflow acquisition system to capture expert know-how, including videos, audios, images, diagrams, textual description, annotations, etc. The AI module of the AI Stephanie system indexes the know-how and creates digital workflows that guide novice users in completing the workflow with features including but not limited to the following. Workflow instructions are translated into multiple languages for users of different languages. Interactive diagrams are made available to illustrate key concepts to the users. Interactive diagrams allow users to input data during the workflow. The collected data are used to further improve the AI. Objects and actions associated with the workflow can be searched. Search history is used to improve the AI and further enhance the workflow guidance.

Other objects and purposes of the invention, and variations thereof, will be apparent upon reading the following specification and inspecting the accompanying drawings.

### BRIEF DESCRIPTION OF THE DRAWINGS

FIG. 1 is a diagrammatic view of a workflow digitizing system and process for digitizing workflows and generating indexed and edited workflow data suitable for knowledge transfer to other persons.

FIG. 2 is a flowchart representing the system and process of the present invention.

FIG. 3 shows a graphical user interface (GUI or UI) of a navigation module provided as part of the inventive system.

FIG. 4 shows the UI with a specific workflow view with a video player.

FIG. 5 shows the UI with a plurality of workflow steps recognized by the AI module and included in the indexed workflow data.

FIG. 6 shows the UI with a search feature and search results displayed.

FIG. 7 shows the UI with a selected workflow step displayed for viewing by a user.

FIG. 8 shows the UI representing a visual search for specific tasks and activities in the workflow steps.

FIG. 9 illustrates the display of a search for secondary information.

FIG. 10 illustrates a language selection and subtitle feature of the UI.

FIG. 11 illustrates video data for a workflow step being performed with subtitles.

FIG. 12A diagrammatically illustrates modules of the present invention comprising a workflow indexer module, AI module, builder module and navigation module.

FIG. 12B diagrammatically illustrates an AI platform solution for the inventive system and process, which captures, indexes and shares know-how for knowledge transfer from an expert to other persons.

FIG. 13 illustrates the inventive system and process and the main phases thereof

FIG. 14A shows a first view of a workflow capturer device operated to capture workflow data including audio and video data.

FIG. 14B shows a second view thereof.

FIG. 15A illustrates an indexing phase or process performed by the AI module.

FIG. 15B illustrates a representation of video, audio and textual data processed through the AI module.

FIG. 16 illustrates a display device with a graphical user interface of the build module for reviewing and editing indexed workflow data generated by the AI module, wherein the UI comprises a text box, a video player and a plurality of visual indicators associated with a plurality of workflow steps.

FIG. 17A illustrates the UI of the build module showing the video player with a selected one of the workflow steps.

FIG. 17B illustrates the UI shows a list or subset of workflow steps.

FIG. 17C shows the UI with a search feature.

FIG. 18 shows a management screen of the UI of the build module allowing a user to visualize and manage workflows captured/created, for example, for an organization.

FIG. 19A shows the UI of the build module displaying an editable text box and video player with the text of a workflow step shown therein.

FIG. 19B shows the UI of the build module with multiple features comprising the text box, video player, a list of workflow steps and a cluster of video segments associated with the workflow steps.

FIG. 19C shows the UI with an enlarged video player and video segments in a timeline order.

FIG. 20A shows the UI with the video player and a step navigation aid.

FIG. 20B shows the UI with a language feature for selected translation and subtitle features.

FIG. 20C shows the UI displaying secondary multi-media content related to the workflow step.

FIG. 20D shows the UI with a step menu interface.

FIG. 20E shows the UI with a search feature and search results having keywords highlighted.

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the arrangement and designated parts thereof. Said terminology will include the words specifically mentioned, derivatives thereof, and words of similar import.

### DETAILED DESCRIPTION

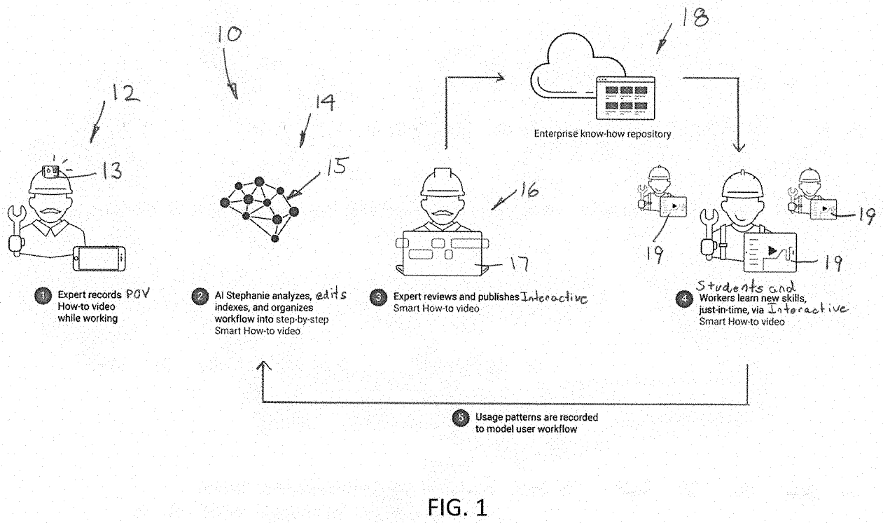

Referring to the present invention as described herein, an inventive AI (artificial intelligence) system 10 (see FIG. 1) is provided, which defines a workflow digitizing system that captures, indexes, and extracts digital workflow of complex technical know-how for designing, manufacturing, operating, maintaining and servicing products, machines and equipment, and turns the digital workflow into a GPS-map like, step-by-step interactive workflow guidance. Generally, the workflow involves multiple related steps performed in a physical spatial environment. While the inventive AI system or workflow digitizing system 10 is particularly suitable for industrial businesses, the inventive AI system 10 also is usable to extract non-industrial workflows such as other processes and task flows that are similarly based upon a specialized skill set and knowledge base. As such, the reference to workflow is not necessarily limited to those encountered in an industrial business but can reference work-related and non-work related process steps performed with or without secondary objects. For example, the workflow may also encompass process steps for using software or a sequence of method steps for performing a particular physical activity. Further, the AI system 10 is particularly useful for workflows associated with various objects such as products, machines, and equipment, although it will be understood that such workflows may simply involve a system of manual or physical techniques by themselves.

A workflow acquisition system 12 forming part of the AI Stephanie system captures and digitizes experts' knowledge and workflow as they are physically performing their work in the work environment. The workflow acquisition system 12 may also be referenced as a workflow capturer or capture module. The workflow acquisition system or workflow capturer 12 includes one or multiple data input devices 13 such as video cameras that capture videos from multiple perspectives, including but not limited to side-view and point-of-view (POV) in which cameras can be head-mounted, eye-wearable, or shoulder-mounted (See FIG. 1 (Step 1)). In Step 1, the data input devices 13 may be used by the expert and/or an operator working with the expert to record the workflows while the expert is working or performing tasks to essentially record a how-to-video of the workflows.

In Step 2, a workflow indexer or indexing module 14 is provided which preferably comprises an AI module 15 generally referenced here as AI Stephanie. The workflow acquisition system 12 captures the physical movements and audio instructions or commentary of an individual such as the expert performing their personal workflow patterns and transfers digitized workflow data to workflow indexing module 14 and the AI module 15 thereof. The physical movements and audio instructions, for example, may be performed in the performance of various tasks or jobs or other technical know-how and may include steps that might be unique to each individual. As such, these tasks may be performed differently between different individuals. These tasks may involve physical movement and audio from one or more individuals, and also may involve the use of objects such as tools and other devices and equipment to perform the task. While the primary type of collected data results from the collection of video and audio data during Step 1, it will be recognized that other input devices may also be used which capture other types of input data such as timing data and sensor data in or around and object relating to movement, location, orientation or other attributes of the individual performing the task and the objects associated therewith. All of this information is captured by the workflow acquisition system 12 wherein the visual, audio, and other performance data is digitized for transfer to the AI module 15 for processing in Step 2.

Preferably, the workflow is unscripted and performed naturally using the individual's expertise and know-how. In other words, the workflow is performed naturally by the individual without relying upon a script prepared beforehand. In effect, the individual performs the task through a stream of consciousness dictated by past training and experience. The AI system 10 does not attempt to instruct the individual but rather, attempts to learn from the individual to teach more novice individuals.

The AI module 15 of the workflow indexing module 14 analyzes the input data and indexes every frame of the videos, including the audio portions thereof, to extract the digital workflow content, such as objects, activities, and states and any other data, from the captured video using AI methods, such as NLP (natural language processing) or computer vision, such as object detection and activity recognition (See FIG. 1 (Step 2)). The digital workflow content may comprise subsets of audio and video data related to the captured audio and video or other data transferred to the AI module 15 for processing. Preferably, the AI module 15 analyzes, edits, and organizes the digital workflow content and automatically generates a step-by-step Interactive How-to Video using the digital workflow content or generate sub-components of a video, which may be individually edited and organized. This autogenerated step-by-step video and each of the video steps can be further reviewed, edited, and organized by a human user or edit. After processing by the AI module 15, the captured data is analyzed, processed and indexed and the Interactive How-to-Video is published to a workflow builder or build module 16, which may be operated on and displayed on the display 17 of a computer or other display device. With the workflow builder 16, the experts can review the automatically extracted digital workflow contents, such as step-by-step information, and can make edits or changes if needed. As noted, the extracted workflow contents preferably are published to the workflow builder 16 as the Interactive How-to-Video, and the expert can review, edit, and publish an edited final video using the workflow builder 16. The editing may be performed on an initial version of an Interactive How-To Video or to the digital workflow content to correct, revise and/or organize the digital workflow content for production of a final version of the Interactive How-To-Video. Experts can also insert additional diagrams or instructions (See FIG. 1 (Step 3)) to supplement the collected workflow data with supplemental training data by using the workflow builder 16 to form digital workflow content that is usable by novices and others to learn the workflows and the know-how associated therewith.

Once the review is done in Step 3, the digital workflow contents are published from the workflow builder or build module 16 to a cloud based enterprise knowledge repository or portal or other data storage medium 18, which is accessible from a remote viewing module such as one or more remote computers 19 or the like that display a workflow navigator or navigation module 20. This data storage repository (or portal or medium) 18 may form part of the indexing module 14 or is accessed by the indexing module 14 for subsequent analysis of any changes to the indexed workflow data or use data generated by the workflow navigator 20. Using the workflow navigator 20, authorized users, such as students and workers, can access these digital workflow content as interactive how-to videos anytime, anywhere through a suitable viewing module and learn at their own pace to teach and train the skilled trades and help speed up their learning curve.(See FIG. 1 (Step 4)). As a result, students and workers learn new skills, just-in-time, via interactive how-to-videos.

In Step 5 of FIG. 1, usage data from the workflow navigator module 20 may be provided as feedback to the AI module 15 to improve the AI system 10.

The inventive AI system 10 promotes the belief that people are the greatest asset to any company or operation: for knowledge, for decision making and for execution. And despite the promise of robots, expert knowledge will remain the most valuable in the foreseeable future. People will continue to be more versatile, faster to train and deploy than any robots across the majority of manufacturing assembly, inspection, service, and logistics tasks for many years to come. Experienced workers embody a wealth of accumulated procedural knowledge, but as subsequent generations retire, this deep know-how is in danger of draining from the companies. Companies will recruit younger generations in increasing numbers, and rather than learning by traditional training classes they will expect new technology to furnish them with just enough information for them to become productive immediately. The AI system 10 of the present invention will facilitate the transition to a new generation of connected digital technicians, and aims to provide a critical platform to serve companies by assisting their workforce and enabling informed and optimized execution.

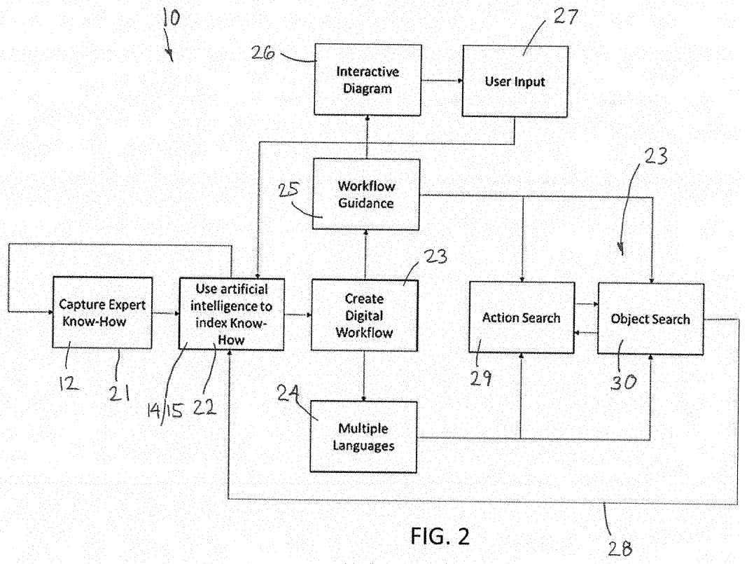

In more detail, the logical diagram of the AI Stephanie system 10 is illustrated in FIG. 2. The AI system 10 uses a variety of tools and methods as the workflow acquisition system 12 to capture expert know-how, including videos, audios, images, diagrams, textual description, annotations, etc. in flowchart step 21. In step 22, the AI module 15 of the AI Stephanie system 10 indexes the know-how and creates digital workflows (step 23) that guide novice users in completing the workflow with features including, but not limited to, the following. Workflow instructions are translated into multiple languages for users of different languages in step 23, preferably by the AI module 15 or a translation module of the workflow indexer 14. Interactive guidance (step 25) and interactive diagrams (step 26) are made available to illustrate key concepts to the users 24. Interactive guidance and diagrams allow users to input data during the workflow editing by the workflow builder 16 that allows user input in (step 27). The collected data are used to further improve the AI module 14 as indicated by data flow arrow 28. When using both the workflow builder 16 and the workflow navigation module 20, objects and actions associated with the workflow can be searched by an action search feature (step 29) and an object search feature (step 30). The search history is used to improve the AI and further enhance the workflow guidance as also indicated by data flow arrow 28.

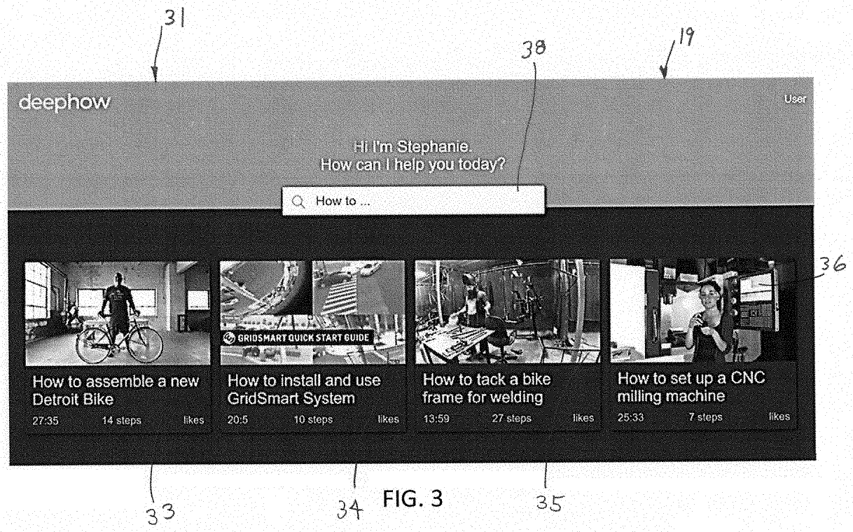

In more detail as to the navigation module 20, FIG. 3 shows a first screen or graphical user interface (GUI) that displays an initial UI 31 (user interface) for students or learners. The inventive AI system 10 uses multiple end user interfaces to optimize knowledge transfer and training to a system user. The UI 31 accesses the enterprise know-how repository or portal 18 through the display device 19 (FIG. 1), wherein FIG. 3 shows that after a user logins into the enterprise know-how portal 18 of a viewing module or display device 19 such as a computer, a workflow list view 32 is displayed, which shows one or more relevant workflows 33-36 for a particular user. In the list view, each workflow 33-36 is presented to the user using a card format. Each card for the respective workflow 33-36 includes basic information about the workflow 33-36 such as the title, the length of the expert's video demonstration, and the number of steps in the respective workflow 33-36. The card for each workflow 33-36 that is displayed on the UI 31 effectively defines an access button that can be clicked, touched, or otherwise activated to link or redirect the user to the next appropriate UI screen.

FIG. 3 therefore illustrates a workflow list view on the UI 31. Each workflow 33-36 links to a video player that allows the user to navigate to the next or previous step. A text search command box 38 also is provided for keyword searching of the data of the workflow information generated by the AI system 10. A voice search feature also is provided that allows the user to provide a voice command to search the workflow information, for example, how to complete a certain task or find a certain object or action in the workflow.

As noted above, the AI module 15 analyzes the input data and indexes every frame of the captured videos, including the captured audio portions thereof, to extract the digital workflow content or step data, such as objects, activities, and states, from the video using AI methods, such as NLP (natural language processing) or computer vision, such as object detection and activity recognition. Therefore, the workflow information not only includes the text data converted from the audio portion, but also additional data identified by the video analysis, which may then be keyword searched using the text search feature or voice search feature. The workflows and the individual steps may be tagged with the workflow information and this information searched to identify particular workflows. The results can then be displayed, for example, in the workflow list view. Once a desired workflow 33-36 is identified and displayed, the user may then activate the workflow button to link to the selected workflow for viewing of the video and the workflow information linked thereto as described in this disclosure.

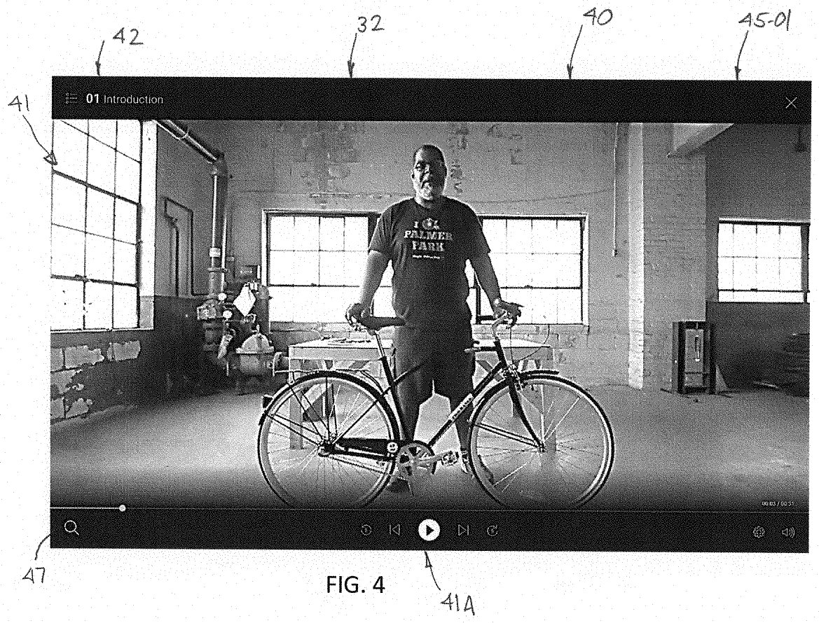

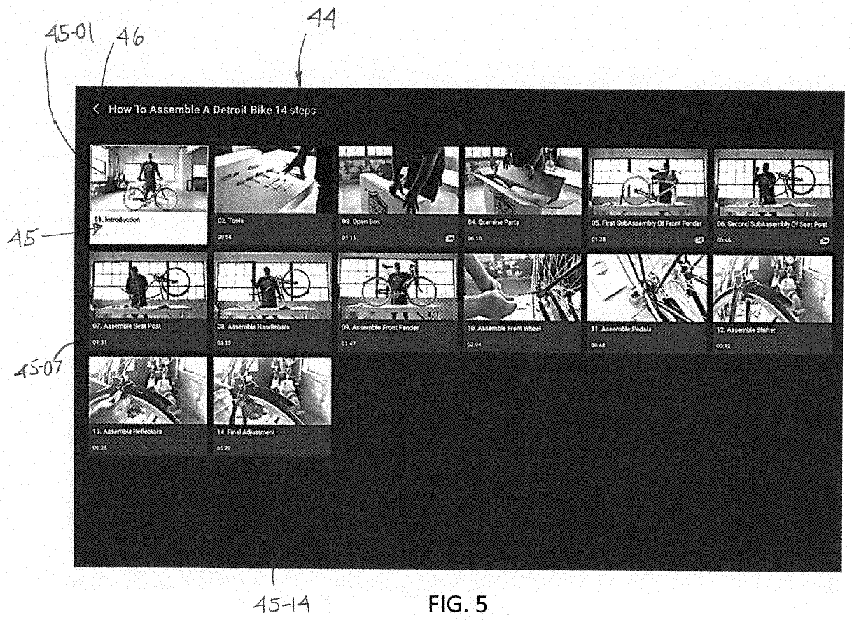

As an example, FIG. 4 shows a specific workflow view in the UI 40 for the desired workflow in this case workflow 32. The UI 40 shows a video viewer or player 41 with video control buttons 41A for selective playing of the workflow video, pausing and rewinding thereof. The UI 40 includes a step navigation aid 42 that allows a user to navigate to a specific task in a workflow. When the step navigation aid 41 is clicked or activated, FIG. 5 shows a UI 44 showing all the steps 45 (steps 45-01 through 45-14) that were extracted by the AI Stephanie system 10, which are automatically shown. In this example, fourteen steps 45 are shown in successive time sequence, wherein any step may be selected to jump to and review the video and other workflow information associated with that step. A navigator button 46 allows a user to return to the UI 40 of FIG. 4.

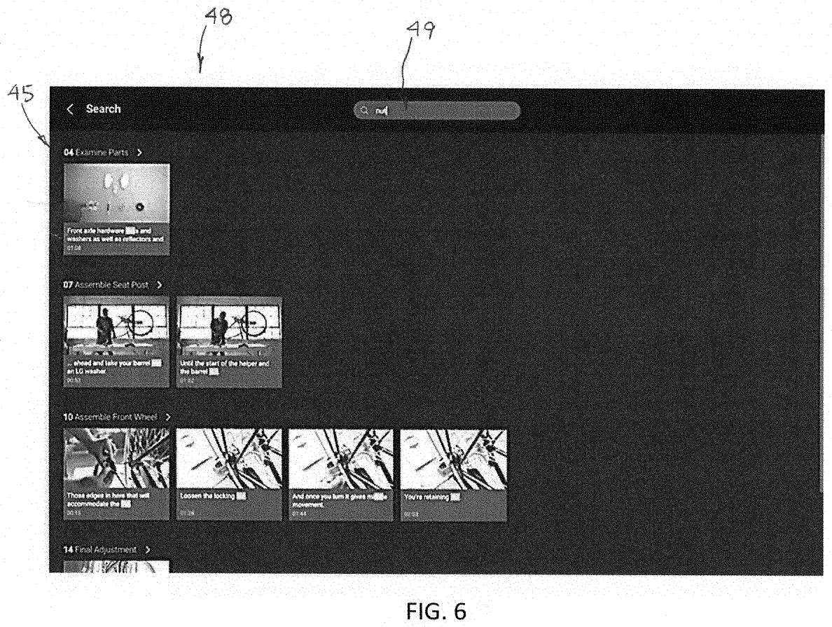

Also as seen in FIG. 4, the UI 40 includes search button 47 that can be activated to allow searching of the workflow 32 with search requests. The search button 47 links or opens the search UI 48, which contains a search command bar 49. With the UI 48 of FIG. 6, users can look for a specific object or objects in any of the steps of a workflow, either by typing in keywords of what he/she is looking for into the search command bar 49 or using their voice commands, such as “Stephanie, Show me bolts and nuts”. Therefore, the search commands can be textual or verbal search requests or possibly other types of search requests such as a representative image search. Once the search request is entered, such as by searching the keyword “nut”, the search request will be converted into embeddings, a high dimensional mathematical vector, wherein FIG. 6 illustrates a subset of the steps 45 that have been tagged by the AI system 10 with keyword data or other search data associated with the search request. In other words, the subset of steps 45 have the term “nut” associated with them or other terms having similar word embeddings since they may refer to a nut or words with similar meanings in the audio data or in the video data. The search results can be specific steps 45-01 to 45-14 or specific video segments within the steps in which the keyword is embedded such phrases in which the word is spoken or an object is displayed. The search term may also be highlighted in the results, such as in a portion of the transcribed text.

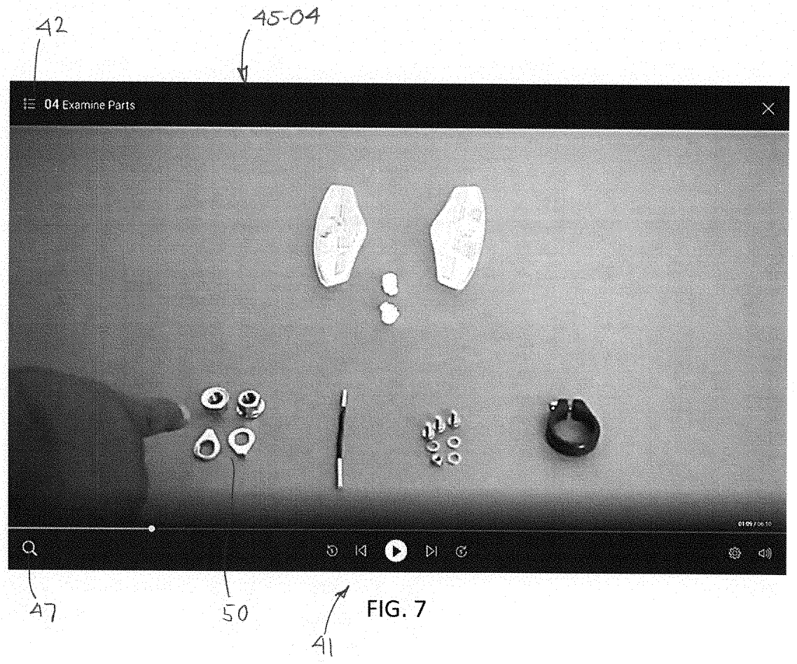

A desired step 45 or a particular segment thereof may then be selected and the selected workflow 45-04 is shown in the video UI 40 as shown in FIG. 7. As can be seen, various nuts 50 are seen in the video. Therefore, with the navigation features of FIGS. 6 and 7, a user can look for a specific object or objects in a particular step, portion of a step or the entire workflow.

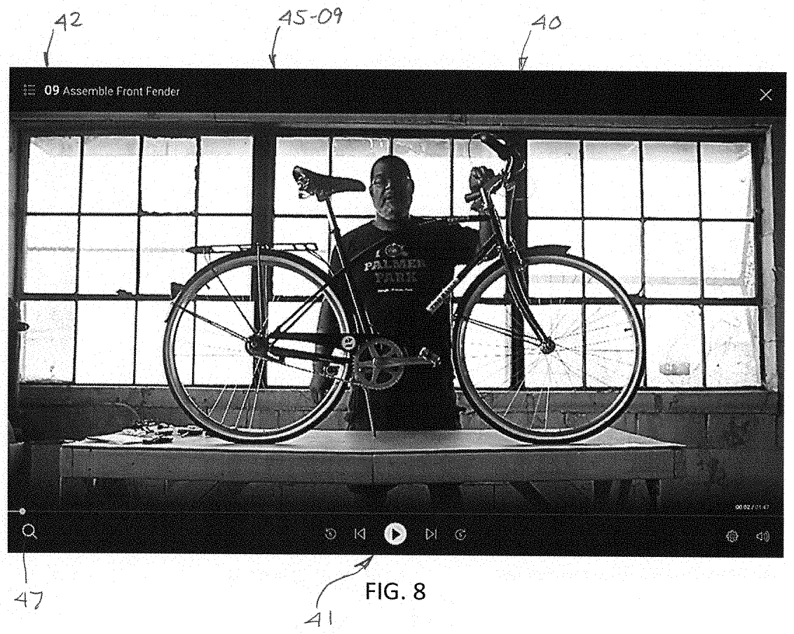

Next as to FIG. 8, in addition to terms and objects, a user can look for a specific activity or task in a workflow. During indexing, the AI of the AI Stephanie module 15 can analyze the audio and video data and any other captured data and learn and identify specific activities or tasks being performed and generate the corresponding step embeddings. The AI module 15 preferably can not only detect when the activity/task is being performed but when it begins and ends. Therefore, when using the navigation module 20, the users can also look for a specific activity or task in a workflow, such as “Stephanie, Show me how to install pedals”, and the navigation module 20 can display step 45-09 which is the workflow portion that displays this activity. The AI module 15 can identify that this is the action being performed by automatic digital recognition thereof during indexing, and does not necessarily require that the task be labelled by the expert during the capture stage with the capturer module 12 or the editor stage with the builder module 16.

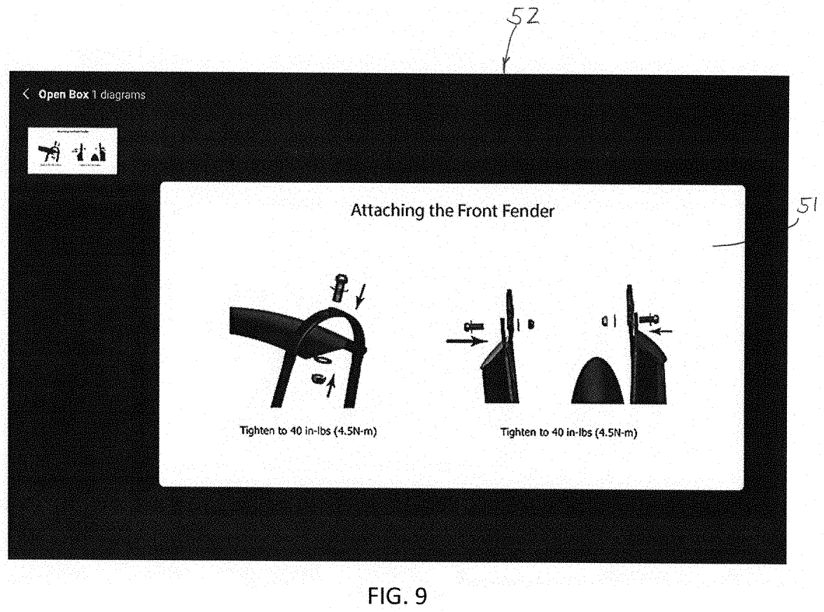

Referring to FIG. 9, the user also can ask for more secondary information 51 during a workflow step, such as “Stephanie, Show me diagram”. The secondary diagram 51 may have been input into the workflow data during editing with the builder module 16 as described above relative to FIG. 2. The AI module 15 may also analyze this secondary information 51 and generate appropriate embeddings or keyword tags to associate the secondary information 51 with the related workflow steps. These interactive diagrams and guidance (steps 25 and 26 of FIG. 2) may be accessed by the navigation module 20 through an interactive UI 52 and displayed in response to search requests or a menu tree that lists the various options for accessing the secondary information.

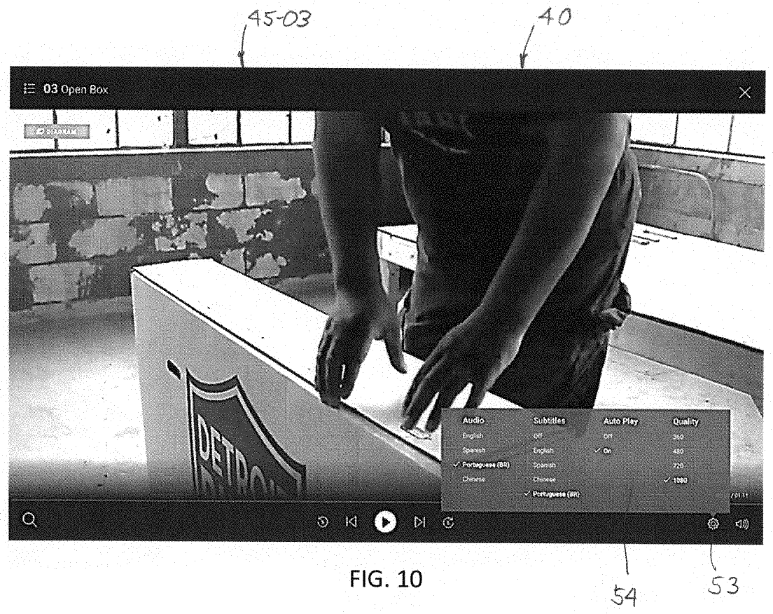

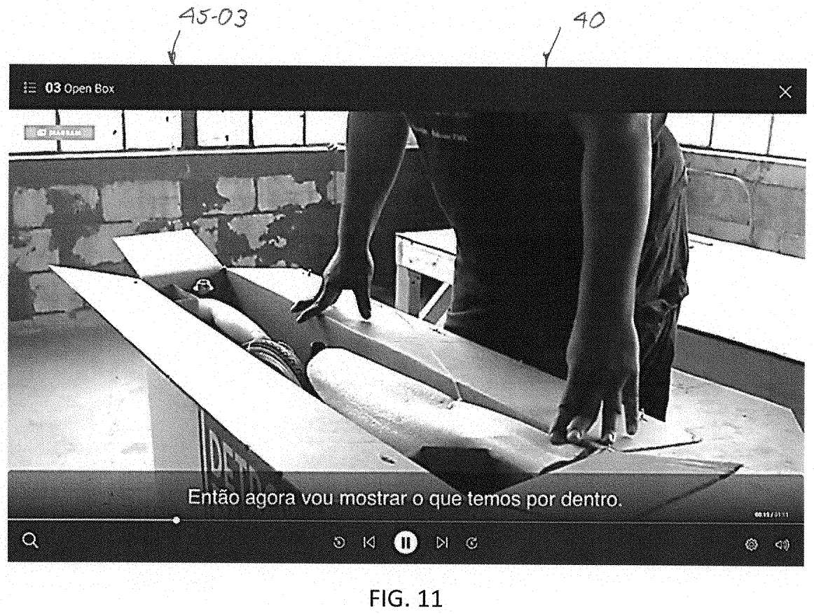

Referring to FIG. 10, users can also change the language of the workflow, and they can also select if they want the associated language subtitles to be displayed on the screen. AI Stephanie module 10 will translate the original language to the selected target language and generate corresponding audios and subtitles during indexing of the captured data or in response to a subsequent request for a translation. The UI 40 includes a settings button 53 that opens an options box 54 that allows the user to access the language data generated by the AI system 10, such as language and subtitles as well as auto play and video resolution options. FIG. 11 shows the workflow 45-03 displayed with translated subtitles. As shown by FIGS. 10 and 11, users can access the workflow content in multiple languages supported by the AI Stephanie system 10, with both voice and subtitles.

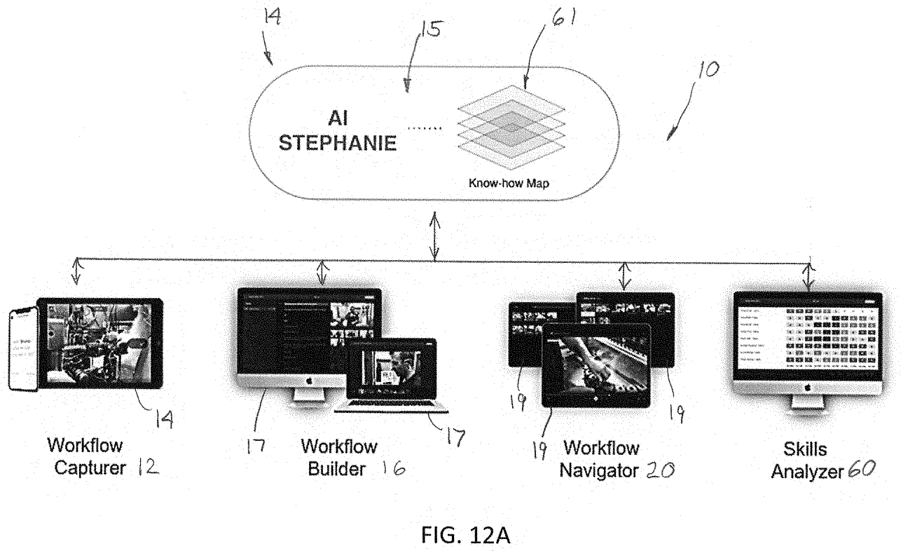

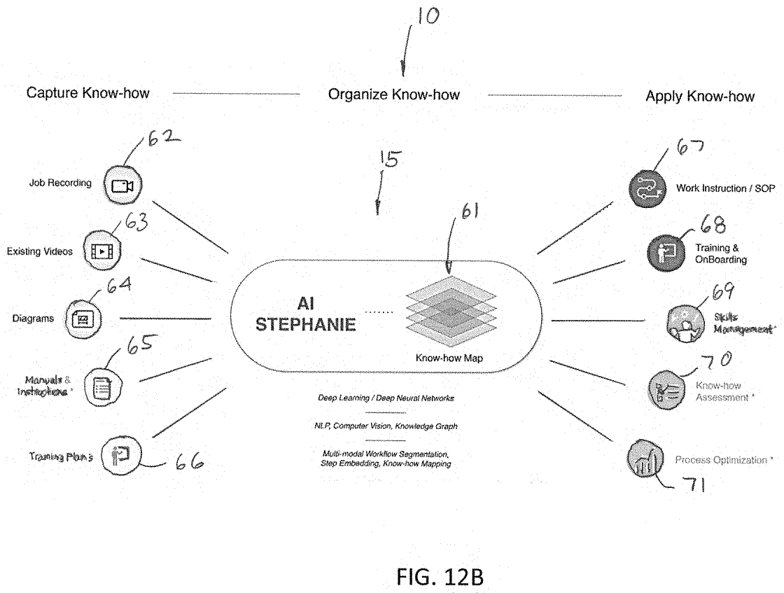

Referring to FIG. 12A, the AI system 10 defines an AI platform solution that captures, indexes and shares experts' know-how, wherein the AI system 10 is scalable for deployment to a number of sites or facilities to capture complex know-how with the workflow capture module 12, organize and index large amounts of complex data with the indexing module 14 and the AI module 15 thereof, refine the results with the build module 16, and disseminate and apply the know-how with the workflow navigation module 20. Additionally, the AI system 10 may further include a skills analyzer module 60 that tracks the usage data obtained by the navigator module 20 and analyzed by the AI module 15 to further improve the knowledge transfer. Preferably, the AI module 15 communicates and interacts with each of the individual modules 12, 16, 20 and 60 to process the data using AI techniques as described herein.

During indexing and analysis by the AI Stephanie module 10, a multi-dimensional know-how map or knowledge graph 61 is generated from the flat or linear data obtained, for example, by the workflow capture module 12. In a sense, a video that is captured is essentially flat data that can be viewed with a viewer over a period of time. The capture module 12 can also capture other data associated with the workflow. During processing of the captured data by the AI module 15, the captured data can be analyzed and processed to identify data components from the audio, video, text, terminology, objects, workflow steps, sensor data, etc. and interlink, tag or associate the data components with other data components, which essentially defines a multi-dimensional know how map or knowledge graph 61.

As disclosed herein, the AI system 10 is an AI-powered knowledge capturing and learning platform, which operates an AI module 15, preferably on a remote server that communicates with the other modules through data connections such as internal and external data networks and the Internet. The workflow capturer module 12 may be a capture app operated on various devices including smartphones or tablets that communicates with video and audio recording features for capturing video of your experts' workflows. The capture app may communicate with the AI module 15 through a broadband connection with the remote AI server on which the AI module 15 operates, or may transmit data to an intermediate device such as a personal computer, which in turn uploads the captured data to the AI module 15 through internal or external networks or a broadband connection to the remote AI server. The workflow builder module 16 may serve as an editor that may run in a Chrome browser operating on the computing device 17 for editing and publishing workflows, or may be its own software application operated independently on the computing device 17. The workflow builder module 16 in turn communicates with the remote AI server using network and/or broadband connections therewith. The navigation module 20 also may be provided as a player that runs in a Chrome browser on a computing device or display device 19 for viewing and searching published workflows. While the capturer module 12, builder module 16, navigation module, and the skills analyzer module 60 may all be provided as separate software applications operated on different computing devices, these modules may also be provided as a single software application. Further, while the modules may be installed locally on computing device, the modules may also be provided as a SAAS program hosted on a remote server and accessed by the various computing devices.

Referring to FIG. 12B, the AI system 10 serves as a workflow digitizing system to capture know-how with the capturer module 12, organize the know-how with the AI module 15 and the builder module 16, and apply the know-how for various practical applications with the navigation module 20 and the skills analyzer 60. Notably, the captured data can not only be sourced by job recording 62 in real-time, but also can be sourced from existing videos 63, diagrams 64, manuals and instructions 65, and training plans 66. Therefore, the captured data can be created or collected in real time or be pre-existing data, wherein the captured data is input to the AI module 15 for analysis and processing and creation of the know-how map 61 by AI Stephanie. The AI module 15 processes the captured data using one or more of the following techniques include deep learning/deep neural networks, natural language processing (NLP), computer vision, knowledge graphing, multi-modal workflow segmentation, step embedding, and know-how mapping.

The AI system 10 is particularly useful for applying the know-how in multiple practical uses with the workflow navigation module 20 and skills analyzer 60. For example, the AI system 10 can be used to produce videos for: work instruction and establishing a standard operating procedure (SOP) 67; training and on-boarding 68; skills management 69; know-how assessment 70; and process optimization 71. These processes further allow the modules 20 and 60 to be used to: capture expert “know how” from an individual before their retirement; safety training; or external training for products used by salespeople and customers. The AI system 10 is also useful for knowledge transfer for these and many other uses.

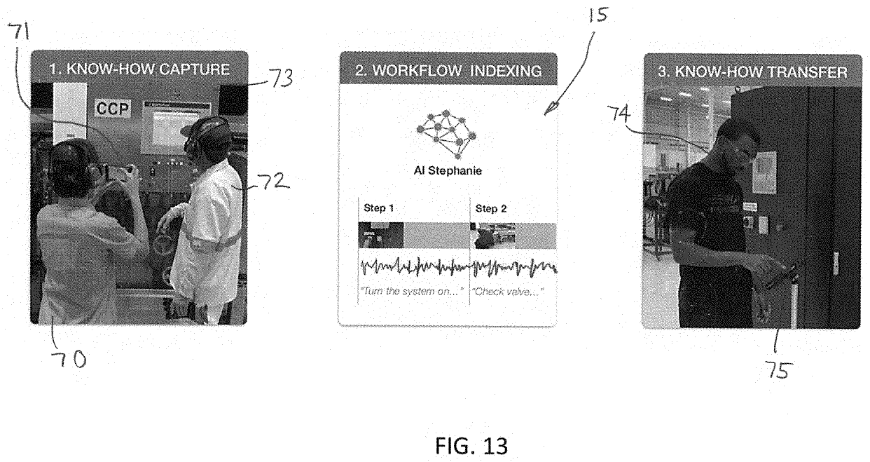

Generally, as shown in FIG. 13, the AI system 10 preferably comprises all of the modules necessary to capture know-how, index workflow, and transfer know-how to another individual, wherein the AI Stephanie module 15 interacts with these phases to simplify the amount of human interaction necessary to complete these tasks. For example, in Step 1 or Phase 1 of FIG. 13, an individual 70 may use capturer device such as a regular smartphone 71 to record an expert 72 doing their normal job, as if they were training an apprentice to use an object 73 such as a machine or the control panel thereof. The captured data can be processed by the AI module 15 to compress and combine video files, optimize audio, and filter out background noise. During the subsequent workflow indexing by the AI module 15 in Step 2 or Phase 2, an expert 72 might only need to perform minor text editing and review on a computer using the workflow builder 16. However, the AI module can receive or upload the captured data to the cloud, and perform process step identification such as identification of workflow steps 1 and 2, and video editing, transcription, and translation of the captured data. During the know-how transfer of Step 3 or Phase 3 to another individual 74, the individual receives just-in-time learning with step by step, smart how-to videos on suitable device such as a smartphone or tablet 75. In turn, the individual can review viewership statistics for continuous improvement, while the AI module 15 can run or collect data on background diagnostics to report on viewership statistics. Therefore, the AI system 10 encompasses both human interaction and background AI processing, wherein the AI processing that may operate at different times or simultaneously with the human interaction.

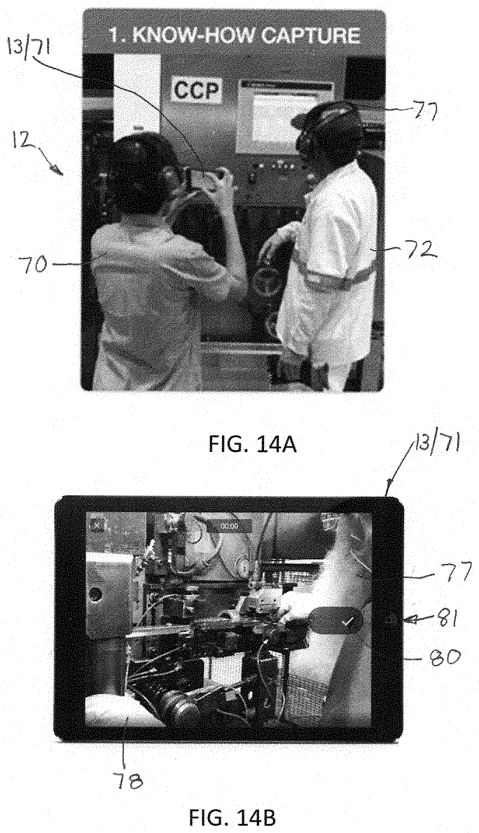

In additional detail as to the human/system interaction, FIGS. 14A and 14B show the workflow capturer module 12 being operated on a capturer device 13/71, which may be a video camera 13 as noted in FIG. 1 that uploads the video to a capture app, or may be the video and audio recorder provided on a computing device such as a smartphone or tablet 71 that operates the capture app during the process of capturing data. The capturer device 13/71 and the capture app serve to capture experts' workflow and know-how via video or other data formats as they are performing real jobs or tasks. On a smartphone or tablet 71, the capture app may be coded as native apps written for the native operating system such as iOS and Android. The capture app allows for multi-language capture, noise resistance to accommodate industrial environments, auto-uploading management to the AI server and easy setup and use.

The AI system 10 may also include an audio input device 77 such as a Bluetooth headset paired with the capturer device 71 and worn by the expert 72. A colleague 70 uses the capture app on the mobile device 71 to record the expert 72. During the video capture or data acquisition, the expert 72 speaks into the headset 77 to describe in a helpful level of detail the sequence of actions that they are performing. Once the expert 72 has completed performance of the workflow, the colleague 70 finalizes the capture process such as by checking a button 80 on the display of the capturer device 13/71. If the expert 72 forgets to include any information or tasks, the expert 72 can perform these tasks out of sequence at the end or at any time during the middle of the video being captured. The AI system 10 allows for identification and reordering of these tasks during the editing stage.

The capture app automatically adds the captured video to a queue to be uploaded to the portal of the AI module 15. As will be described below, once uploaded, the AI Stephanie module 15 analyzes the sequence of actions performed by the expert along with the descriptive narration, in order to break the video and audio into discrete steps. The capture app is downloaded to and works on a mobile device 71 and the user signs into the program. The capture app may include a language setting that defines the preferred spoken language of the expert that will be captured. While this will simplify processing of the captured data by the AI module 15, the AI module 15 may also analyze the text and identify the language of the expert.

The capture app also stores and may display a list of previously captured workflows. The capture app automatically adds a freshly captured workflow video to this queue for uploading to the AI portal, which may be immediate or may be delayed to time when Internet connectivity becomes available. The capture app includes a record video button that begins a live recording of an expert as they perform their workflow. The capture app also includes an import video button to upload a previously recorded video stored on the mobile device to the AI portal. During recording, the expert 72 preferably provides a spoken commentary throughout the workflow to help the viewers better understand the task and also allow the AI module 15 to transcribe the commentary during indexing thereof.

During recording, it is preferred to begin a workflow by focusing the camera on the expert's face and upper torso, and allowing them to introduce themself and describe the objective of the workflow. This data may be used by the AI module 15 to identify the expert 72 within the video as it analyzes objects acted upon by the expert 72. Once the expert 72 begins their work, capturer device 71 and the camera thereof preferably is focused on the physical task that the expert is performing with their hands and tools. When the workflow has been captured, the check mark button 80 adjacent to the record button 81 is activated. The captured workflow can then be uploaded to the AI portal for processing by the AI Stephanie module 15.

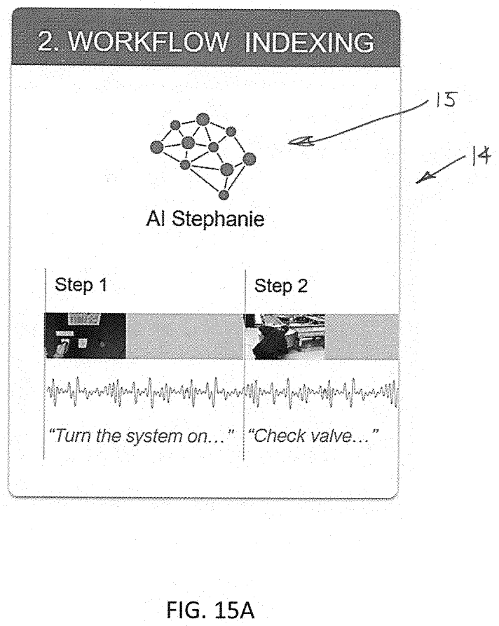

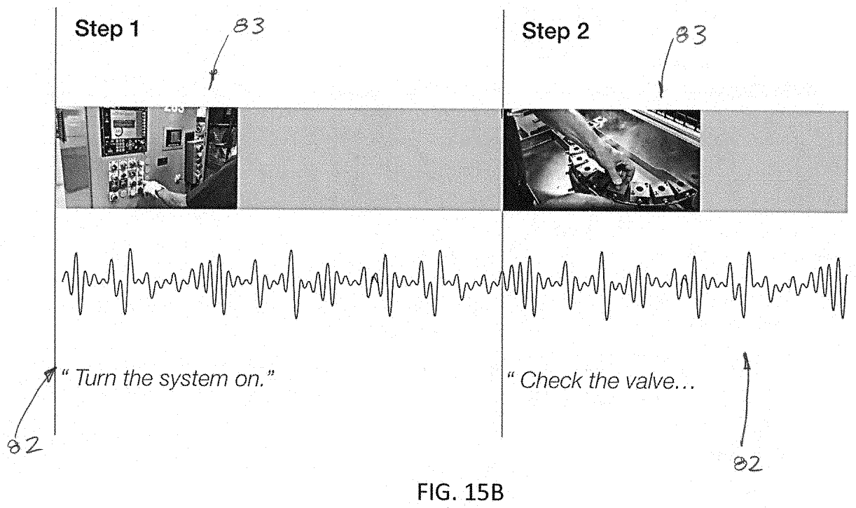

Referring to FIGS. 15A and 15B, the AI module 15 of the AI workflow indexer 16 incorporates multiple processes and techniques to process, analyze and index the captured data. For example, the AI module 15 may use natural language processing (NLP) to identify and transcribe the text of the audio data 82. Also, the AI module 15 may use image analysis and computer vision to analyze the video data 83, identify the machines, equipment, parts, tools and/or other objects in the video and reference the visual or object data with the text data. The AI module 15 may use stored or learned object data to identify and detect objects seen in the videos and/or may identify the objects through comparison with keywords in the text data or physical motions of the expert seen in the video data. This is analysis is diagrammatically illustrated in FIG. 15B. The AI module can parse the text data and video data and then link related text and objects such as by tagging or linking visual objects and text together in the know-how or data map 61. This tagging or linking can be performed for text and visual data that is captured simultaneously but also can be applied to text and visual data occurring at other times in the captured video and audio. The AI module 15 can learn objects and text and identify other occurrences of such objects or terminology throughout the entire workflow process or timeline. As such, the AI Stephanie module 16 analyzes, indexes, and segments videos into key workflow steps and generates the multi-dimensional know-how map described above.

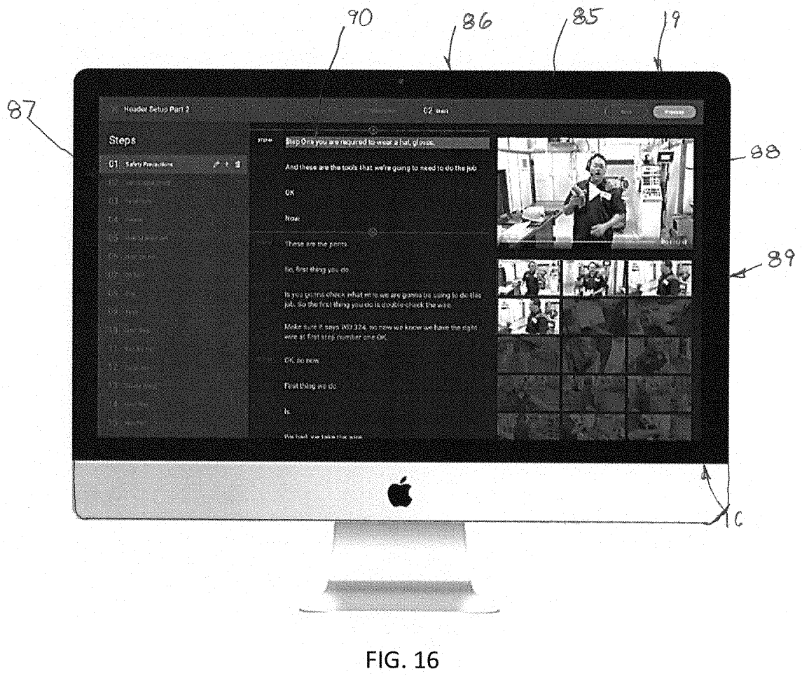

The AI module 15 therefore may: perform auto-tagging of key words and key images; auto-segment videos into steps; auto-summarize step names; perform multi-language conversion; and perform auto-subtitle generation. The indexed data and the data associated with the know-how map is initially generated by the AI module 15 and then can then be published to the workflow builder 16 as seen in FIG. 16.

FIG. 16 illustrates the workflow builder 16, which may be a program or app operated on a remoting computing device 19 or accessed through a computing device 19 if a SAAS configuration in accord with the description herein. The computing device 19 may have a display 85 showing a user interface (UI) 86, which includes the indexed information generated by the indexing operation performed by the AI module 15 as described above. From the builder UI 86, the expert can review the workflow video that he had prepared in the initial capturing step after the video has been processed or indexed by the AI module 15.

In particular, the UI 86 may include an indexed list of workflow steps 87 that lists the steps 87 as identified by the AI module 15. The UI 86 also includes a player 88 for playing the how-to-video, and displays the segmented workflow steps 89 in a cluster of screenshots. Further, a text box 90 is displayed which displays the transcribed text that allows for minor text editing and review by the expert. The transcribed text is also used in the navigation module for subtitles. The workflow builder 16 therefore serves to seamlessly integrate video, diagrams, subtitles, and translations to view and edit initial how-to-videos after indexing and then deliver smart how-to videos.

The UI 86 of the workflow builder 16 allows the expert to review the process workflow data and build the workflow from modular steps. While the AI module 15 initially identifies the workflow steps based upon the use of AI techniques, the expert may review and reconfigure the workflow steps using the UI 86. Also, the expert or other editor may link interactive diagrams to the text and video segments and can perform annotation and video trimming of the processed video. The UI 86 also permits screen captures and once editing is completed by the workflow builder 16, the final, edited video file may be uploaded to the AI module 15. The AI module 15 can then publish or share the workflow video to the workflow navigator 20 for later know how transfer. Further, the AI module 15 can further analyze the edits and changes and essentially learn from the edits and update the know-how map 61. The workflow builder 16 also allows the creation of workflow collections and workflow library management.

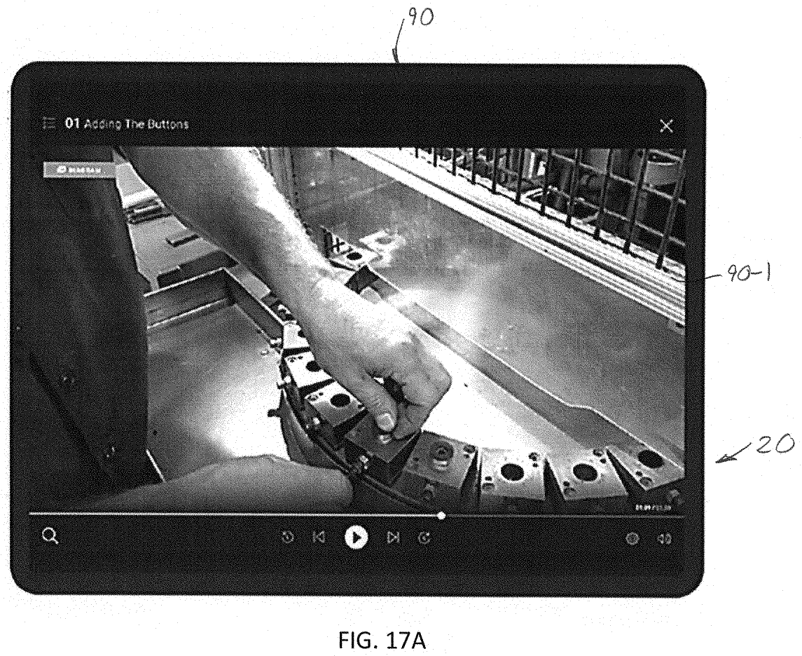

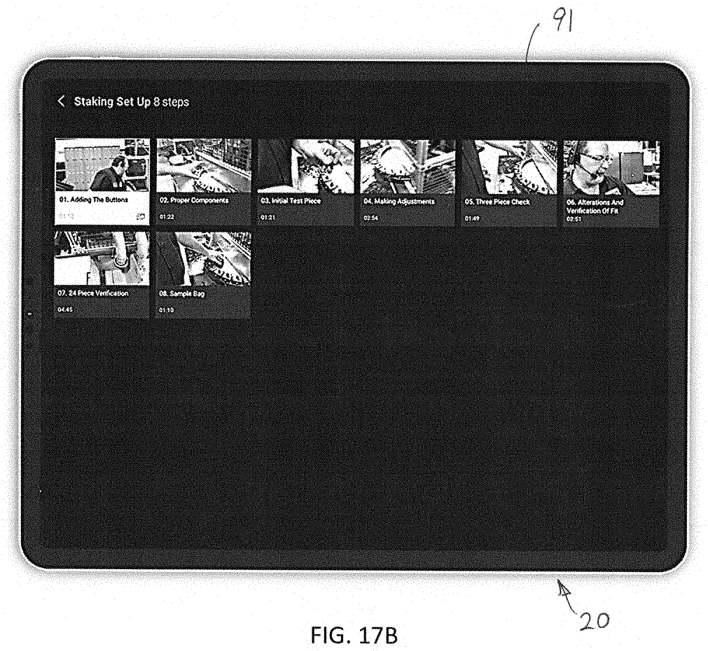

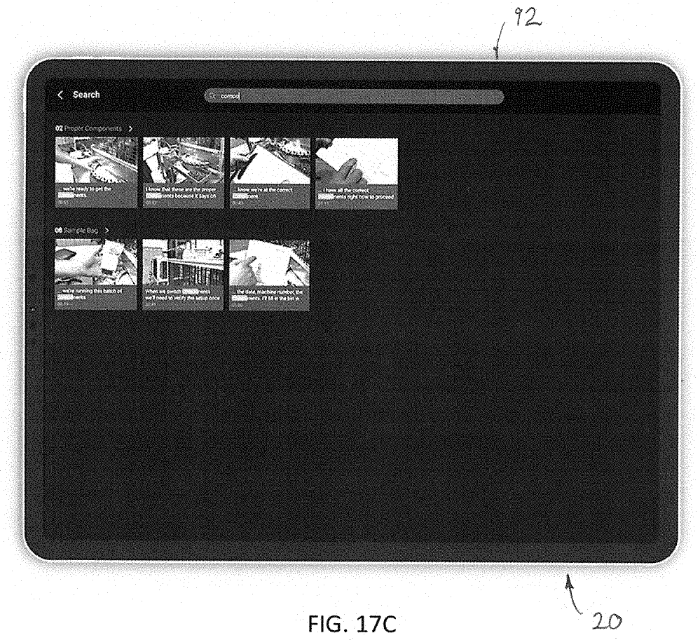

As described above, the workflow navigator 20 may then be used to transfer know-how to other individuals. FIG. 17A illustrates the UI 90 with the first step 91-01 of a workflow 90. FIG. 17B shows that a list of steps may displayed in the step listing UI 91, and as seen in FIG. 17C, these steps of the workflow 90 are searchable in the search UI 92. The workflow navigator 20 thereby serves to deliver step-by-step workflow guidance in multiple languages in accord with the description herein. The workflow navigator 20 also supports powerful in-video search through the search UI 92, wherein users can interact with AI module 15 to access and watch new videos or rewatch videos to learn anytime, anywhere at their own pace. As described herein relative to FIGS. 17A-17C and FIGS. 1-11, the workflow navigator 20 provides an interactive steps menu, step-by-step navigation of the workflow steps, in-video search by key words and key frames, contextual diagram viewing, multi-language audio, multi-language subtitles, and adaptive video resolutions.

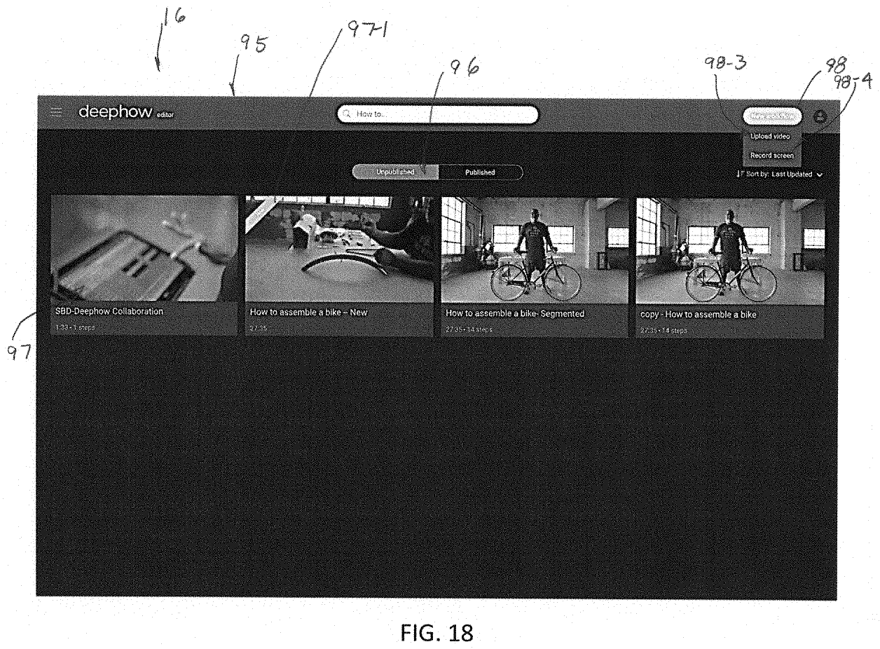

In more detail as to FIG. 18 and additional features of the AI system 10, the workflow builder 16 may be used for workflow management. The workflow builder 16 may operate on a display device as described above, and displays a UI 95 that enables a user to visualize and manage all the workflows captured/created inside the organization. The UI 95 includes a toggle button 96 that can be toggled between unpublished and published workflows that can be displayed in the UI 95 as a subset 97 of the workflows. This feature enables the user to control which workflows are reviewed and made public, and which ones are under review and should remain unpublished.

Further, a dropdown menu button 98 can be activated to control additional features. The menu may include an upload video button 98-3 that enables the user to upload workflows via video files such as mp4 files to the AI module 15, and may include a record screen button 98-4 that enables the user to activate screen recording and use the resulting video as a workflow that can be uploaded to the AI module 15. Therefore, rather than record physical movements of an expert as described above, a workflow using onscreen actions and steps can be recorded from a display screen and then that captured video is uploaded for indexing and editing as described herein.

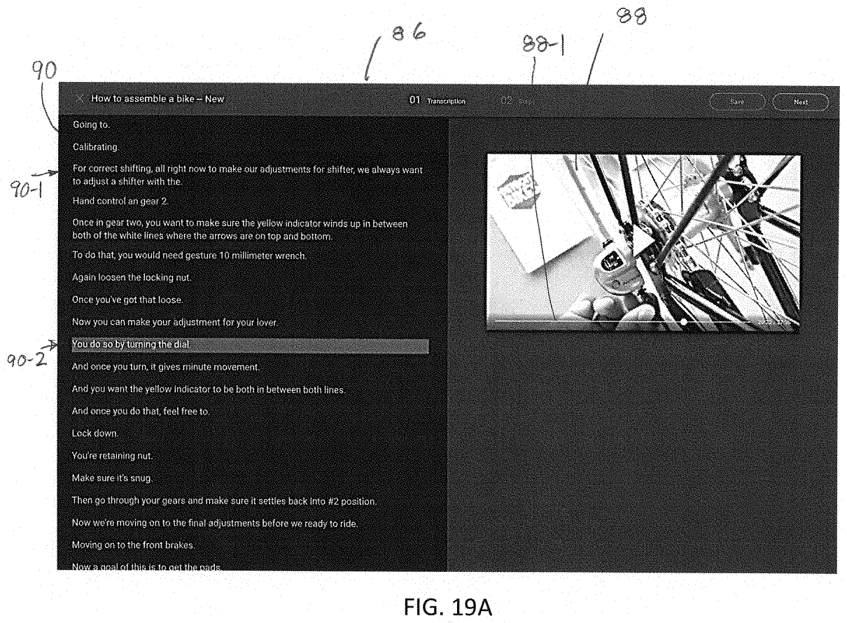

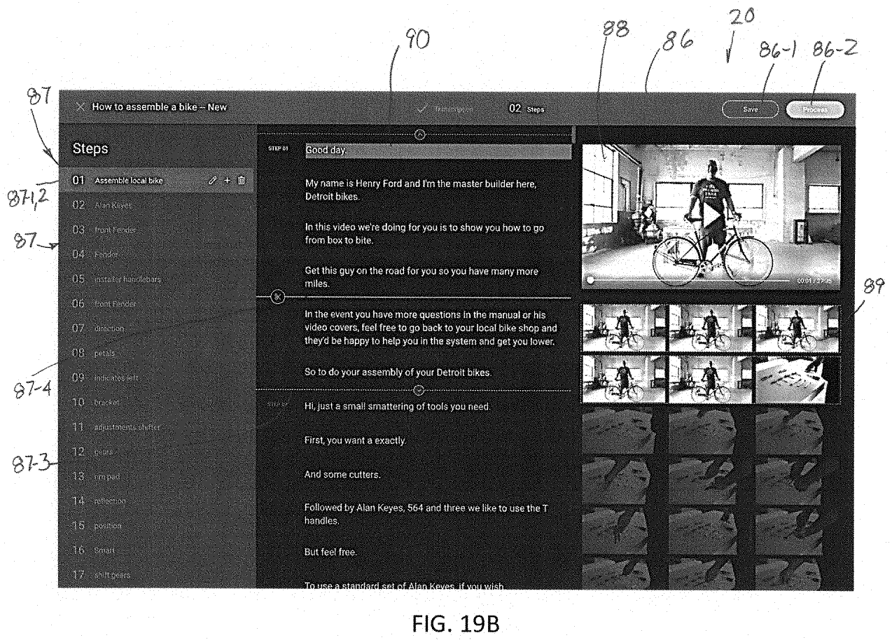

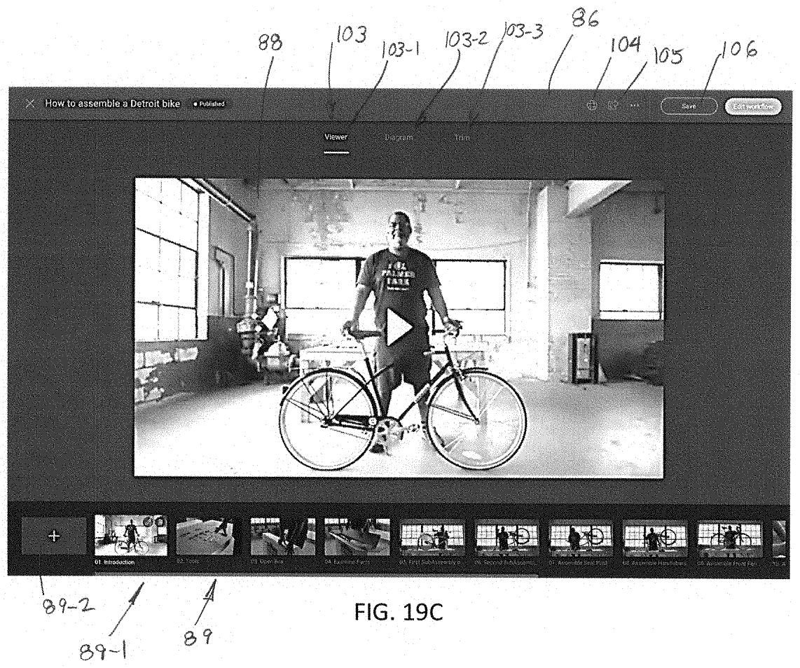

Next as to the workflow builder 20 shown in FIGS. 19A-19C, the workflow builder 16 may be accessed through a browser on the display device 19. In FIG. 19A, the AI Stephanie module 15 has transcribed the audio data as disclosed herein, and displays to the user all of the content spoken by the expert in the video in the text box 90. Therefore, the AI system 10 removes the need for the user to transcribe the captured data, facilitates and speeds up user understanding of the indexed video shown in the player 88, and enables the AI module 15 to auto generate subtitles to reduce manual user work.

As one feature, the transcribed text may be displayed as sentences or phrases 90-1 in the text box wherein the displayed text corresponds to the time stamp or time location in the corresponding video shown in the video player 88. While the video may be viewed using a timeline bar 88-1 with a moving cursor, a line of selected text 90-2 may be selected by the user, which forwards or rewinds the video player 88 to that same location. As such, this feature enables video navigation via interacting with the displayed text 90-1 and selected sentences 90-1 thereof instead of timeline navigation using the timeline bar 88-1.

The accuracy of the text 90-1 may be reviewed and corrected by the user using conventional or virtual keyboards or other text entry options. The text box feature creates a seamless collaboration between the users and editors and the AI results generated by the AI module 15. This editing feature ultimately speeds up the content review process, particularly since the editors can view the text and video objects together to clarify any questions about the correct text.

In FIG. 19B, an alternate mode for the UI 86 is shown, which includes the text box 90 and player 88 as well as the list of workflow steps 87 and cluster of workflow steps 89. The UI 86 in this mode is particularly suitable for revising transcription while also reconfiguring the segmentation of the steps or work instructions in the indexed workflow. As indicated by reference numerals 87-1,2, the AI module 15 auto segments the work instructions, which are displayed in the list of workflow steps 87, and summarizes the steps through AI generated suggestions for step titles. These step titles may be edited by the editor.

As additional features, the workflow builder 20 also enables the expert or editor to edit the initial segmentation that was auto generated by AI Stephanie module 15. As seen at location 87-1,2, the first step 01 is highlighted, which in turn highlights the block of text to show the break point 87-3 between step 01 and the next successive step 02 or a prior successive step. The break point 87-3 may also be shown as a visible marker in the text box 90. If the editor wishes to modify this break point, the marker at break point 87-3 might be moved such by dragging the marker to new location 87-4. This shortens the length of introduction step 01 and lengthens the length of next step 02. This process may be reversed as well. Therefore, while the AI module 15 exhibits the intelligence to identify a suitable break point, the editor may refine that initial break point location. This still saves editing time since the estimated break point typically is close to where an editor would logically break two steps apart. When this edit is fed back to the AI module 15, the AI module 15 may analyze the edit and modify its estimation of break points for future videos. Also, when editing the break point 87-3 to 87-4, this action in the text box 90 automatically edits the video segments as well so that the editor does not need to review the video segments 89 to edit their individual length.

Referring to FIG. 19C, the workflow builder 20 also has additional features to facilitate editing of the video. The UI 86 may be switched to an alternate mode for additional editing features. In this mode, the player 88 is enlarged and the video segments for the steps 88 are shown in a timeline order 89-1. The workflow builder 16 permits navigation and editing of individual workflow steps which serve as building blocks for the entire workflow. In FIG. 19C, the editor may also modify the order of the steps in a workflow, for example, by dragging a video segment to a new location within the displayed timeline. In one example, an expert might forget to include a step at the usual location in the workflow during the capturing process but go back and perform the step later, knowing that the workflow builder 20 will allow the step to be edited and moved to the proper location in the timeline order 89-1.

An insert button 89-2 may also be provided which enables the editor to import steps from other workflows and insert these new imported steps into the timeline.

The workflow builder 16 also includes a toolset for enhancing the steps beyond basic video capabilities by permitting the addition of different layers of information associated or linked to a workflow step. The UI 86 may display one or more buttons 103, including the viewer button 103-1 as shown in FIG. 19C. The UI 86 also may include a diagram button 103-2 and a trim button 103-3. For example, with the diagram button 103-2, an editor can link layers of information such as diagrams, annotations, manuals, guidance, and the like that could be viewed to more fully understand the workflow step.

Also, a language button 104 may be provided to enable the user to select languages that instruct the AI Stephanie module 15 to auto translate into a selected language if it has not done so already. This feature also allows the user to review/edit the translation.

A further feature is accessed by a tool button 105, which enables sharing of the workflow in different formats and media: QR Code, web link, embed video code, mp4 with subtitles, etc.

In more detail as to the above-described features, using the UI 95 of FIG. 18, an editor or user can switch between an editor mode and a player mode by clicking on a menu button provided in the UI 95. As described above, the UI 95 includes the unpublished and published buttons 96 for switching between the collections of the corresponding workflows. Newly captured workflows appear in the unpublished collection and are denoted by an indicator 97-1 such as a diagonal band across the top left corner and labeled as New. For editing, the user can select one of the displayed videos 97 to work on.

In a first step in the editing process as seen in FIG. 19A, the user will review the text 90-1 in the text box 90 to review the accuracy of the text transcription that was spoken by the expert during the course of the workflow. The AI system 10 makes this convenient by providing a synchronization between the captured video shown in the player 88 on the right hand side and the corresponding text transcription in the text box 90 on the left hand side.

If the user notices any spelling errors in the text transcription, the user can just click on the word and correct as a person would in a regular text editor. The AI system preferably avoids editing of the text to join text lines to form a paragraph since paragraph blocks of text may result in long text subtitles and may also disrupt the timing synchronization between the video and subtitles. If a word or phrase appears incorrectly at multiple places throughout the transcription, the workflow builder 16 includes a Find and Replace feature. Once the minor changes have been made to the text, the user can click on the save button to commit the changes to the AI portal for use by the AI module 15.

The user can then click to move to the second step of the editing process shown in FIG. 19B. Again, the goal for this second step in the editing process is to review the sequence of steps and step labels listed in the step listing 87 on the left hand side of UI 86. As noted, the step listing has been prepared and proposed by the AI Stephanie module 15 during analysis of the captured video and audio. The AI module 15 makes this convenient by providing a synchronization between the step name in step list 87, the step transcribed text in text box 90, and the video for the step shown in player 88 together with a selection of representative frames from the video as shown in the cluster of step video segments 89.

If the user wishes to rename a step, they can click on the step name in the step list 87 to edit. If they wish to adjust the beginning or end of the step boundary such as at 87-3, they can move the step boundary 87-3. For example, the user can click and hold a circular icon in the middle of the dotted step boundary such as at position 87-3 and drag the step boundary up or down to the desired position such as position 87-4. This adjustment of the step boundary will also adjust the representative video frame show in the video segments 89.

As another feature, the user can delete a step if it is not needed, by clicking on a step trash can icon provided on the UI 86. Note that this does not delete the transcribed text or corresponding video, but it only removes the step grouping. Similarly, the user can add a step either by clicking on the plus icon in the step list 87, or by cutting a specific step into two parts by clicking on the scissor icon. The user can then name the new step in the step list 87. Once any of these minor changes have been made, the user can click on the save button 86-1 to commit the edits or changes to the AI portal. The user can then click a process button 86-2 to move to the final step of the editing process shown in FIG. 19C.

After opening the workflow to the UI 86 of FIG. 19C, we can see along the bottom of the UI 86 a numerically ordered sequence of workflow steps 89 with a representative image. If desired, the user can click on any step in the workflow steps 89 and watch the corresponding video in the player 88 in the center of the page.

Assuming the sequence of steps 89 is acceptable after editing, the user can click on the publish or save button 106 to confirm their intent to publish. The user may now close this workflow and return to the main screen of the editor shown in FIG. 18. As expected, the new workflow now appears in the published collection of the workflows 97 and is available for colleagues to watch.

Further, the user can edit the arrangement of workflow steps 89 as described above relative to FIG. 19C. As described above, the user can re-order the sequence of steps by clicking and holding and dragging a step to another position in the sequence of steps 89. Further, the user can add one or more additional steps to the sequence by clicking on the add icon 89-2, selecting the required step from the collection and clicking on the insert button at the bottom of the page. The new step appears at the beginning of the workflow steps 89, and the user can drag the new step to the desired position as shown earlier. Similarly, the user can remove a step from the sequence by moving a mouse or other selector over the step image and click on the trash can icon, and confirm the deletion.

At times, a diagram may help convey information. The diagram may be stored separately in a digital image format. The user can associate the diagram with a specific step 89 by selecting the step and then clicking on the diagram button or tool 103-2. This allows the user to drag and drop an image file, or select from a file chooser, the image that they wish to associate with this step.

If there is excess video at the beginning or end of a specific step that needs to be removed, then the user can use the trim tool with the trim button 103-3. The user can select the step and click on the trim button 103-3. The user can click on a handle icon at a beginning or end of the video timeline and move to the desired position. Press the play button in the player 88 to review the trim selection. The user then selects a trim button on the page to perform the trim action.

The language of the video may also be edited. In an exemplary workflow, the expert may be speaking English during the capturing step. However, the AI system 10 can translate the expert's language into a number of available languages. When the user clicks on the translation icon 104 in the top right, the UI 86 will display on a side of the screen the English text transcription of the expert. By clicking on a plus icon on the screen UI 86, the user will then see a list of target languages to which the English text can be translates. For example, the user may select Spanish, and AI Stephanie module 15 will receive the command, translate the original text and transmit the translated text to the workflow navigator 16, wherein the UI 86 will display the English text on the left and the Spanish text on the right. A bilingual English and Spanish speaker can then use the synchronization feature to review the accuracy of the technical language when translated into Spanish. As before, the user can hit the save button 106 to commit any changes, and close the translation tool.

Here again, the user can click on the publish button and confirm their intent to publish. The user can now close this workflow and return to the main screen of the editor in FIG. 18. The new workflow now appears in the published collection and is available for colleagues to watch. Once published, the user can share this edited workflow with others by clicking on the sharing icon. When sharing, the AI system 10 can generate a unique link that the user can share with anyone to allow them to view only this workflow or workflow step in the player of the workflow navigator 20. Alternatively, an HTML code snippet can be copied and pasted into another platform or website to make this workflow available. Still further, a single workflow step can be download as a basic MP4 file

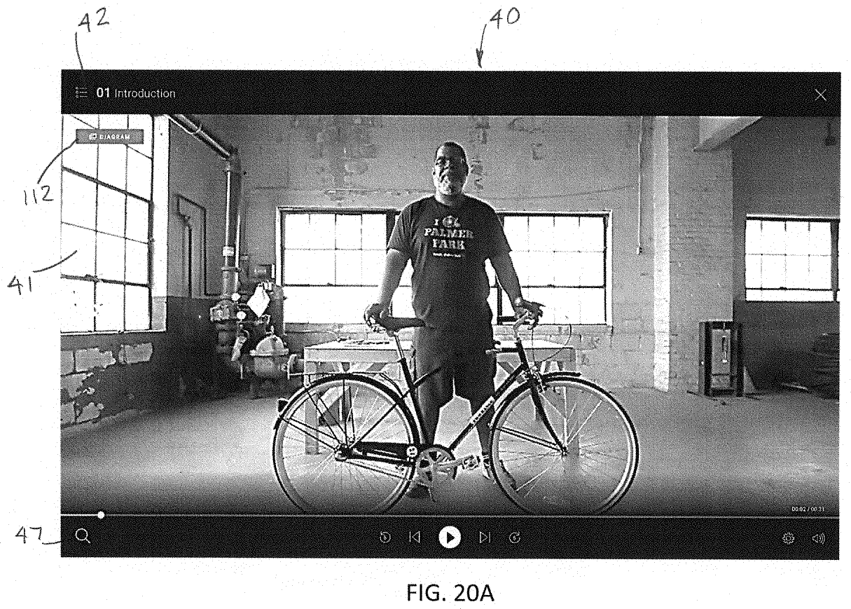

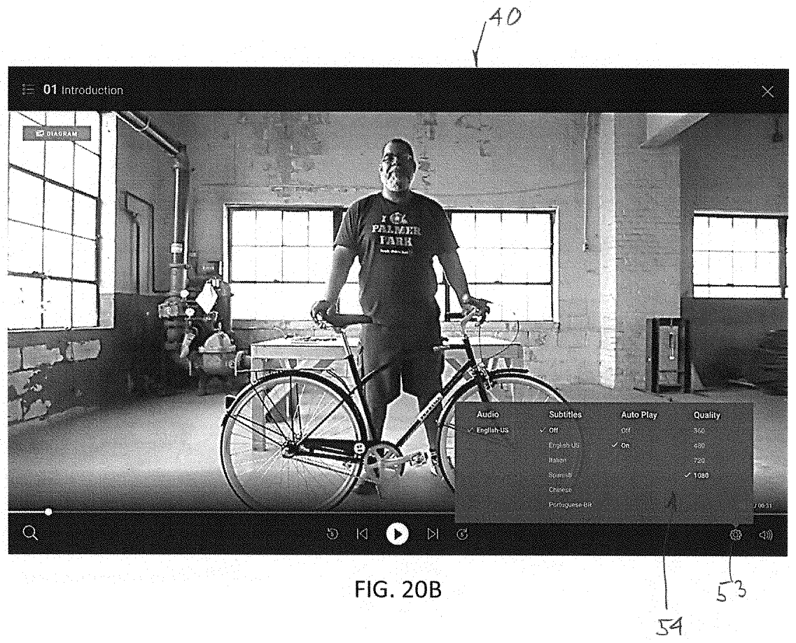

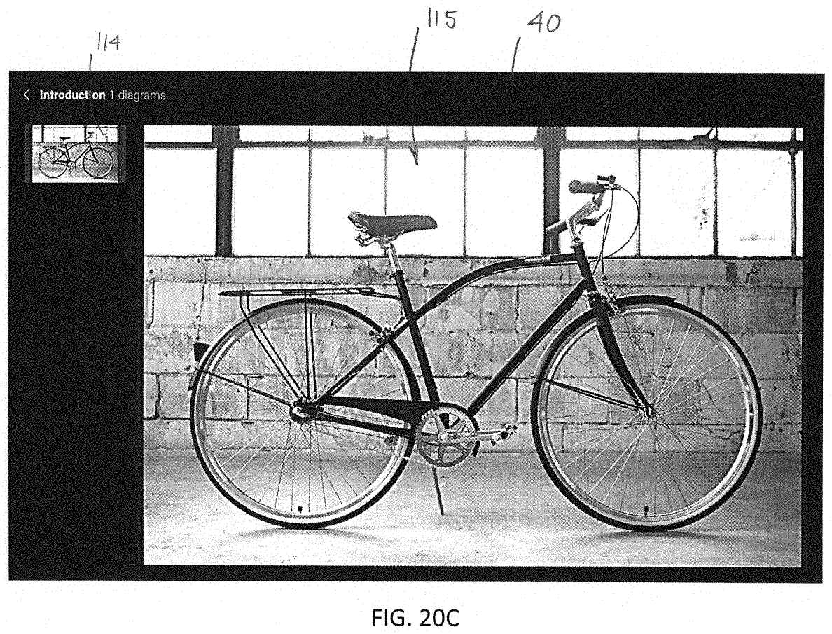

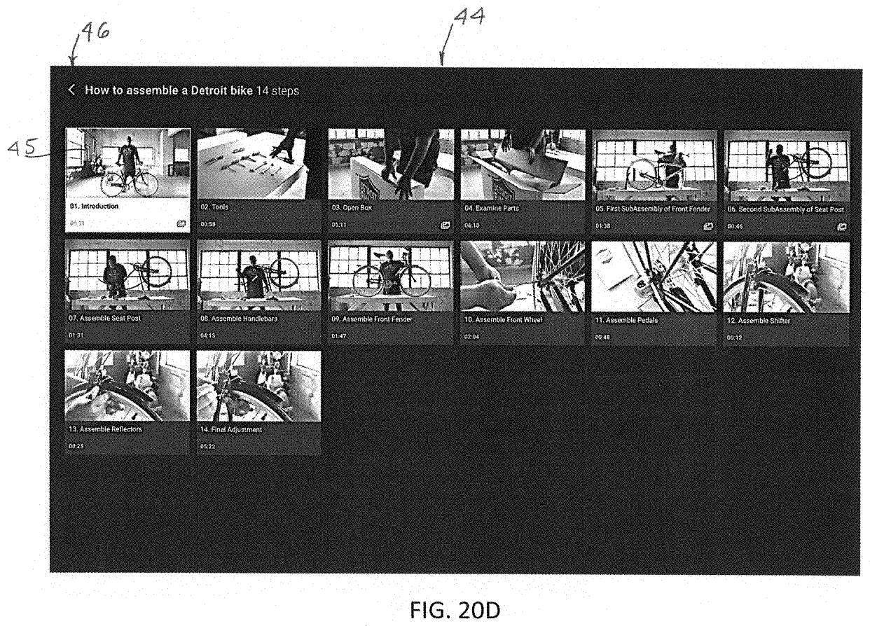

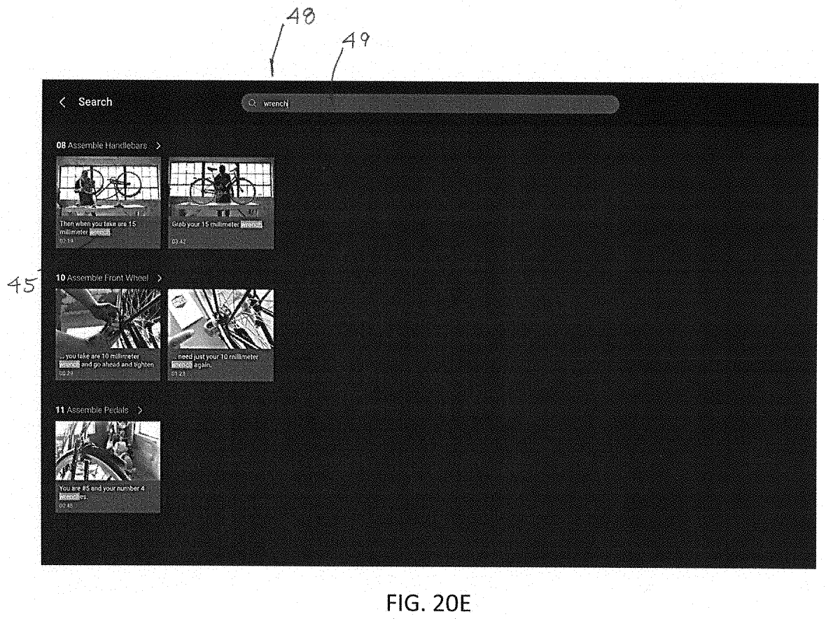

Next, the above-described workflow navigator 20 is further shown in FIGS. 20A-20E, wherein the following description supplements the disclosure of the workflow navigator 20 previously shown in FIGS. 4-11 above. FIG. 20A shows a specific workflow view of the UI 40 for the desired workflow, here again using the workflow 32 for reference. The UI 40 includes the player 41 for selective playing of the workflow video, pausing and rewinding thereof. The UI 40 includes the step navigation aid 42 that accesses a step menu interface that allows a user to navigate to a specific task in a workflow. The step menu interface provides an overview of all the steps in a workflow instruction, as well as the capability to select one of the steps to be played.

The UI 40 also includes a diagram access button 112 that provides access to a diagram interface. The diagram interface enables users to view and browse through additional media content (diagrams, PDF, images, links, etc.) that are related to the specific open step. The search button 47 provides access to an advanced in-video search, which enables users to search for key-words, key-objects, or key-images inside the video content of the workflow as described above.

Referring to FIG. 20B, users can still change the language of the workflow, and they can also select if they want the associated language subtitles to be displayed on the screen. The UI 40 includes the settings button 53 that opens an expanded options box 54 that allows the user to access the language data generated by the AI system 10, such as language and subtitles as well as auto play and video resolution options. The options box 54 allows the user to turn on/off the AI autogenerated subtitles as well as a voice over that enables users to listen and/or read the content in a language that is more convenient to them.

Referring to FIG. 20C, the diagram interface 114 enables users to view and browse through additional multi-media content (diagrams, PDF, images, links, etc.) that are related to the specific open step. A viewer 115 is provided for viewing one or more diagrams or other content displaced in the diagram interface 114. As a result, the workflow 32 is no longer a static video, but a complex combination of different layers of information and meta data regards to the specific target topic that was captured as a workflow.

Referring to FIG. 20D, the navigation aid button 42 provides access to the step menu interface. The step men interface provides an overview of all the steps in a workflow instruction 32, as well as the capability to select one of the steps to be played. The UI 44 shows all of the steps 45 (steps 45-01 through 45-14) that are automatically shown. In this example, fourteen steps 45 are shown in successive time sequence, wherein any step may be selected to jump to and review the video and other workflow information associated with that step. A navigator button 46 allows a user to return to the UI 40 of FIG. 20A.

Next as to FIG. 20E, the search button 47 provides access to the advanced in-video search, which enables users to search for key-words, key-objects, or key-images inside the video content of the workflow. With the UI 48 of FIG. 20E, users can look for a specific object or objects in any of the steps of a workflow, either by typing in key-words of what he/she is looking for into the search command bar 49 or using their voice commands, such as “Stephanie, Show me wrenches”. Therefore, the search commands can be textual or verbal search requests or possibly other types of search requests such as a representative image search. Once the search request is entered, such by searching the keyword “wrench”, FIG. 20E illustrates a subset of the steps 45 that have been tagged by the AI system 10 with keyword data or other search data associated with the search request. In other words, the subset of steps 45 have the term “wrench” associated with them.

Although particular preferred embodiments of the invention have been disclosed in detail for illustrative purposes, it will be recognized that variations or modifications of the disclosed apparatus, including the rearrangement of parts, lie within the scope of the present invention.

What is claimed:

1. A workflow analyzing system for digitizing workflows comprising:
a capture device for capturing performance of a workflow, wherein said workflow comprises individual workflow steps performed in a sequence by a person, said capture device configured to capture audio data and video data during the performance of said workflow steps and digitizing said audio data and said video data to define workflow data;
an indexing system operated on a server to process and index said workflow data and automatically identify said workflow steps from said workflow data, wherein said indexing system communicates with said capture device to receive and store said workflow data on said server, said indexing system comprising a processor and an AI module that performs artificial intelligence techniques with said processor to analyze said workflow data and automatically recognize said workflow steps within said workflow data to generate indexed workflow data, said indexed workflow data comprising subsets of step data indexed by said AI module wherein said step data comprises text, audio and/or video data associated with each of said workflow steps; and
a build module operated on a computing device to generate a user interface displayed on a display device, said build module communicating with said indexing system to receive said indexed data and display said indexed data to an editor through said user interface for editing of said subsets of step data to define edited workflow data for use in subsequent transfer of knowledge to one or more other persons.

2. The workflow analyzing system according to claim 1, wherein said user interface of said indexing system selectively displays said workflow steps by displaying said subsets of step data associated with said workflow steps.

3. The workflow analyzing system according to claim 2, wherein said subsets of step data are modifiable by said editor when displayed to create modified subsets of step data within said edited workflow data.

4. The workflow analyzing system according to claim 1, wherein said build module further comprises digital editing tools for editing of said subsets of step data comprising said text, audio and/or video data initially indexed by said AI module to generate said edited workflow data.

5. The workflow analyzing system according to claim 1, which further comprises a workflow navigation module operated on a computing device which communicates with said indexing system and includes a user interface displayed on a display device, said user interface of said navigation module displaying said edited workflow data for said knowledge transfer to said other persons and including navigation tools to review said workflow steps represented by said subsets of step data displayed in the form of said audio and video data associated therewith.

6. The workflow analyzing system according to claim 5, wherein said text data is editable in said build module and is transferred to and analyzed by said AI module to identify keywords for use with a search tool in said workflow navigation module and for use with a subtitle feature of a video player on which said video data and audio data are performed.

7. The workflow analyzing system according to claim 1, wherein said AI module transcribes said audio data of said workflow data received from said capture device which is stored as said text data, said AI module analyzing said text data for keywords which are associated with said audio data and said video data to generate keyword data, said build module including a search module for searching said indexed workflow data to identify any said subsets of step data associated with said keywords for display by said build module.

8. The workflow analyzing system according to claim 7, which further comprises a workflow navigation module operated on a computing device which communicates with said indexing system and includes a user interface displayed on a display device, said user interface of said navigation module displaying said edited workflow data and including navigation tools to review said workflow steps represented by said subsets of step data displayed in the form of said audio and video data associated therewith, said navigation tools including a search tool for searching said keyword data and displaying any said workflow steps linked to such keyword data.

9. The workflow analyzer system according to claim 1, wherein said AI module transcribes said audio data of said workflow data received from said capture device which is transcribed and stored as said text data, said AI module analyzing said text data for keywords which are associated with said audio data and said video data of said subsets of step data to generate keyword data, said AI module further analyzing said video data using at least one of object recognition and activity recognition techniques and identifying objects and activities associated with said keywords and storing results from said analyzing with said keyword data.

10. The workflow analyzing system according to claim 1, wherein said build module displays said text data simultaneously with said video data, wherein said text data includes break point indicators indicating break points in said text data between each of said workflow steps, wherein said break point indicators are movable within said text data for adjusting beginning and end points of successive workflow steps, said workflow analyzing system automatically adjusting beginning and end points of said video data to correspond with said adjusting of said text data.

11. The workflow analyzing system according to claim 1, wherein said AI module automatically analyzes said edited workflow data and adjusts said AI techniques for use on future analysis of subsequent workflow data.

12. The workflow analyzing system according to claim 1, which further includes a navigation module which communicates with said indexing system and displays said edited workflow data for knowledge transfer by said one or more other persons and generates use data, which is transferred to said indexing module, said AI module analyzing said edited workflow data and said use data and updating said AI techniques in response thereto.

13. A workflow analyzing process for digitizing workflows comprising the steps of:
storing workflow data comprised of audio data and video data documenting knowledge related to a performance of a workflow, said workflow comprising individual workflow steps performed in a sequence;
transferring said workflow data to an indexing system operated on a server;
processing said workflow data to automatically index said workflow data with said indexing system by identifying said workflow steps from said workflow data and generating indexed workflow data;
said indexing step comprising the stem of performing artificial intelligence techniques with an AI module operated on a computer processor to analyze said workflow data and automatically recognize said workflow steps within said workflow data and generate said indexed workflow data, said indexed workflow data comprising subsets of step data wherein said each subset of step data comprises text, audio and/or video data associated with each of said workflow steps recognized by said AI module; and
editing said indexed workflow data with a build module operated on a computing device receiving said indexed data from said indexing system;
said editing step comprising the steps of displaying said indexed workflow data to an editor through a user interface on a display device in the form of transcribed text data generated by said AI module and said audio and/or video data captured by said capture device, and editing any of said text data and said audio and video data to generate edited workflow data for subsequent knowledge transfer.

14. The workflow analyzing process according to claim 13, further comprising the steps of:
capturing said performance of said workflow with a capture device to obtain said audio data and said video data; and
digitizing said audio data and video data using said capture device during the performance of said workflow steps to define workflow data, which is transferred to said indexing system.

15. The workflow analyzing process according to claim 14, comprising the step of transferring said edited workflow data to said indexing system and transferring said indexed workflow data to a navigation module for use in subsequent transfer of knowledge to one or more persons.

16. The workflow analyzing process according to claim 15, wherein the step of displaying said indexed workflow data comprises displaying said subsets of step data in said indexed workflow data associated with each of said workflow steps.

17. The workflow analyzing process according to claim 13, further comprising the steps of:
transcribing said audio data of said workflow data to generate said text data; and
analyzing said text data by said AI module to identify keywords which are associated with said audio data and said video data of said subsets of step data to generate keyword data; and
analyzing said video data by said AI module using at least one of object recognition and activity recognition techniques and identifying objects and activities associated with said keywords and storing results from said analyzing with said keyword data.

18. The workflow analyzing process according to claim 17, further including the steps of :
displaying said text data simultaneously with said video data with said text data including break point indicators indicating break points in said text data between each of said workflow steps, wherein said break point indicators are movable within said text data for adjusting beginning and end points of successive workflow steps; and
automatically adjusting said video data to correspond with said adjusting.

19. A workflow analyzing system for digitizing workflows comprising:
a build module operated on a computing device to generate a user interface displayed on a display device, said build module communicating with an indexing system to receive indexed workflow data comprising subsets of step data wherein said step data comprises text, audio and/or video data associated with each step of a sequence of workflow steps performed in a workflow, said build module comprising a graphical display comprising a video player for playing said video data for any of said workflow steps, a step display area displaying one or more indicators for said workflow steps respectively, and a text box displaying said text associated with a selected one of said workflow steps and any beginning and end portions of said text data for any of said workflow steps preceding or following said selected workflow step, said graphical display further comprising break point indicators within said text box indicating break points in said text data between each of said selected workflow step and any of said beginning and end portions of said text data preceding or following said selected workflow step, said break point indicators being movable within said text data for adjusting beginning and end points of successive workflow steps, and said workflow analyzing system automatically adjusting said video data to correspond with said adjusting.

20. The workflow analyzing system according to claim 19, wherein graphical display includes tool buttons for converting said display to a search tool, a text editing tool, a video play screen, and combinations thereof.
